(19) United States
(12) Patent Application Publication
(10) Pub. No.: US 2025/0323003 A1
(43) Pub. Date: Oct. 16, 2025

(54) ARC INDUCTION UNIT AND DIRECT CURRENT RELAY COMPRISING SAME

(71) Applicant: LS ELECTRIC CO., LTD., Anyang-si, Gyeonggi-do (KR)

(72) Inventors: Ha Su KIM, Anyang-si, Gyeonggi-do (KR); Jin Hee PARK, Anyang-si, Gyeonggi-do (KR)

(21) Appl. No.: 18/291,894

(22) PCT Filed: Oct. 17, 2022
(86) PCT No.: PCT/KR2022/015775

§ 371 Date: Aug. 12, 2024

(30) Foreign Application Priority Data
Nov. 23, 2021 (KR) 10-2021-0162024

(51) Int. Cl. H01H 50/38; H01H 9/44; H01H 50/02; H01H 50/18; H01H 50/54

(52) U.S. Cl. CPC H01H 50/38; H01H 9/443; H01H 50/02; H01H 50/18; H01H 50/546

(57) ABSTRACT

An arc inducing part and a direct current relay including the same are disclosed. The arc inducing part and a direct current relay including the same according to one aspect of the present disclosure may include a magnet housing coupled to the outside of an arc chamber, wherein the arc chamber partially accommodates a fixed contactor; and a magnet part accommodated in a magnet space formed in the magnet housing to form a magnetic field inside the arc chamber, and wherein a plurality of fixed contacts are provided and the plurality of fixed contacts are disposed to be spaced apart from each other in one direction inside the arc chamber, and wherein the magnet part may be disposed along the other direction that forms a predetermined angle with the one direction.

### FIELD

The present disclosure relates to a direct current (DC) relay, and more particularly, to a DC relay having a structure capable of effectively extinguishing an arc while securing a sufficient insulating distance.

### BACKGROUND

A direct current (DC) relay is a device that transmits a mechanical drive or current signal using the principle of an electromagnet. The DC relay is also called an electromagnetic switch, and is generally classified as an electrical circuit switching device.

The DC relay includes a fixed contact and a movable contact. The fixed contact is electrically connected to an external power source and load. The fixed contact and the movable contact may be in contact with each other or spaced apart from each other.

By contact and separation between the fixed contact and the movable contact, applying electric current through the DC relay is allowed or blocked. The movement is achieved by a driving unit that applies a driving force to the movable contact.

When the fixed contact and the movable contact are spaced apart, an arc is generated between the fixed contact and the movable contact. An arc is a flow of high-voltage, high-temperature current. Therefore, the generated arc must be quickly discharged from the DC relay through a predetermined path.

The discharge path of the arc is formed by a magnet provided in the DC relay. The magnet forms a magnetic field inside a space where the fixed contact and the movable contact are in contact with each other. The discharge path of the arc may be formed by the electromagnetic force generated by the formed magnetic field and current flow.

Meanwhile, the longer the generated arc extends, the greater the extinguishing effect. Therefore, in order for the generated arc to be effectively extinguished and then discharged, it is advantageous for the space inside the arc chamber to be larger.

However, it is general that the magnet for forming the magnetic field is provided in the arc chamber, that is, a space in which the fixed contact and the movable contact are accommodated. In this case, the size of the space inside the arc chamber may be reduced by the space occupied by the magnet.

Therefore, in order to effectively induce and extinguish the arc, the space of the arc chamber must be increased while the magnet for inducing the arc is provided.

Korean Patent Registration No. 10-1661396 discloses an electromagnetic relay. Specifically, the electromagnetic relay for inducing the generated arc using permanent magnets disposed surrounding the fixed contact and the movable contact is disclosed.

However, the permanent magnets of the electromagnetic relay disclosed by the prior document is disposed on the inner surface of the extension part forming a portion of the arc chamber. That is, the electromagnetic relay according to the previous document does not suggest a method for solving the problem of the arc flow space being reduced by the space occupied by the permanent magnets.

Korean Patent Registration No. 10-1631000 discloses an electromagnetic relay. Specifically, the electromagnetic relay for inducing the generated arc using permanent magnets disposed surrounding the fixed contact and the movable contact is disclosed.

However, the permanent magnets of the electromagnetic relay disclosed by the prior document is accommodated in a space additionally formed inside the housing. Therefore, the possibility of damage caused by the generated arc may not be excluded, and the space additionally formed is a space in which the arc cannot still flow, so there is a limit to improving the extinguishing ability of the arc.

Korean Patent Laid-open Publication No. 10-2013-0136978 discloses a contact device and an electromagnetic switch using the same. Specifically, the contact device for inducing a generated arc by embedding the permanent magnets for extinguishing the arc inside a fixed contactor, and an electromagnetic switch using the same are disclosed.

However, the permanent magnets of the contactor device and the electromagnetic switch using the same disclosed by the prior document are accommodated inside the fixed contactor, which is a point where the arc occurs. Therefore, it is difficult to exclude the possibility that the permanent magnets are damaged by the generated arc. In addition, since the permanent magnets must be accommodated in the fixed contactor in a state in which its polarity direction is fixed, there is a high possibility of misassembling and the like, and there is concern that manufacturability may be reduced.
(Patent Document 1) Korean Patent Registration No. 10-166139 6 (2016 Sep. 29)
(Patent Document 2) Korean Patent Registration No. 10-1631000 (2016 Jun. 15)
(Patent Document 3) Korean Patent Laid-open Publication No. 10-2013-0136978 (2013 Dec. 13)

### SUMMARY

### Technical Problem

The present disclosure is intended to solve the above problems, and it is an object of the present disclosure to provide an arc inducing part having a structure capable of inducing an arc generated and preventing damage to other components, and a DC relay including the same.

Another object of the present disclosure is to provide an arc inducing part having a structure capable of sufficiently securing an arc extinguishing space and a DC relay including the same.

Still another object of the present disclosure is to provide an arc inducing part having a structure capable of simplifying manufacturing and maintenance and a DC relay including the same.

Still another object of the present disclosure is to provide an arc inducing part having a structure capable of inducing an arc regardless of the polarity of an external load or power source to be electrically connected, and a DC relay including the same.

Still another object of the present disclosure is to provide an arc inducing part having a structure capable of improving design freedom and manufacturing ability, and a DC relay including the same.

The problems of the present disclosure are not limited to those mentioned above, and other problems not mentioned will be clearly understood by those of ordinary skill in the art from the following description.

### Technical Solution

According to one aspect of the present disclosure, an arc inducing part may be provided, including a magnet housing coupled to the outside of an arc chamber, wherein the arc chamber partially accommodates a fixed contactor; and a magnet part accommodated in a magnet space formed in the magnet housing to form a magnetic field inside the arc chamber; wherein a plurality of fixed contacts are provided and the plurality of fixed contacts are disposed to be spaced apart from each other in one direction inside the arc chamber, and wherein the magnet part is disposed along the other direction that forms a predetermined angle with the one direction.

At this time, the arc inducing part may be provided, in which the magnet housing includes a support wall that partially surrounds an outer circumferential surface of the arc chamber; and a cover member that surrounds one surface of the arc chamber in a height direction and is continuous with the support wall, respectively, and wherein the magnet space is formed inside the support wall.

In addition, the arc inducing part may be provided, in which the magnet space is formed through the support wall in a thickness direction.

At this time, the arc inducing part may be provided, in which a plurality of support walls is provided, and the plurality of the support walls are disposed to surround different portions of the outer circumferential surface of the arc chamber, and wherein the magnet part includes a plurality of magnets, and the plurality of magnets are each accommodated in a plurality of magnet spaces to form a magnetic field inside the arc chamber.

In addition, the arc inducing part may be provided, in which the plurality of support walls are disposed to be spaced apart from each other by a predetermined distance along the outer circumference of the cover member.

At this time, the arc inducing part may be provided, in which the plurality of magnets includes a magnet outer surface that is one surface opposite to the arc chamber; and a magnet inner surface that is the other surface opposite to the outer surface of the magnet and facing the arc chamber, and wherein each of the magnet outer surfaces of the plurality of magnets is magnetized with the same polarity.

In addition, the arc inducing part may be provided, in which the support wall includes a first support wall and a third support wall that are disposed to face each other with the arc chamber interposed therebetween and extend in one direction; and a second support wall and a fourth support wall that are disposed to face each other with the arc chamber interposed therebetween and extend in the other direction.

At this time, the arc inducing part may be provided, in which the support wall has a horizontal cross-section with the first support wall, the second support wall, the third support wall, and the fourth support wall as one side, respectively, and the support wall has a diamond shape with one diagonal line in one direction, in which the plurality of fixed contactors are disposed side by side.

In addition, the arc inducing part may be provided, in which the first support wall and the third support wall extend parallel to each other by the same length, and the second support wall and the fourth support wall extend parallel to each other by the same length.

At this time, the arc inducing part may be provided, in which the shortest distance between any one of a plurality of fixed contactors and the magnet part is different from the shortest distance between the other one of the plurality of fixed contactors and the magnet part.

In addition, the arc inducing part may be provided, in which the arc inducing part includes a magnet cover member coupled to cover the magnet housing and the magnet part from the outside to support the magnet housing and the magnet part from the outside.

At this time, the arc inducing part may be provided, in which the magnet part includes a plurality of magnets disposed to be spaced apart from each other, and wherein the magnet cover member includes a first extension part for extending in one direction to cover any one of the plurality of magnets disposed adjacent to each other from the outside; a second extension part continuous with the first extension part to cover a space between the plurality of magnets disposed adjacent to each other; and a third extension part continuous with the second extension part to cover the other of the plurality of magnets disposed adjacent to each other from the outside.

In addition, the arc inducing part may be provided, in which the first extension part and the third extension part extend in a planar shape, and the second extension part extends in a curved shape including at least one curved portion.

According to other aspect of the present disclosure, a direct current relay may be provided, including a plurality of fixed contactors electrically connected to an external power source or an external load, and disposed to be spaced apart in one direction; a movable contactor provided to be lifted up and down in a direction toward and opposite to the fixed contact, and configured to be in contact with or spaced apart from the fixed contactor; an arc chamber having a chamber space formed therein to accommodate portions of a plurality of fixed contactors and the movable contactor; and an arc inducing part that surrounds the outside of the arc chamber and is coupled to the arc chamber to form a magnetic field in the chamber space, wherein the arc chamber includes a plurality of walls for surrounding the chamber space and extending in one direction and another direction, respectively, and wherein the arc inducing part includes a plurality of magnets disposed adjacent to each of the plurality of walls and extending in the same direction as the plurality of walls.

At this time, the DC relay may be provided, in which the arc inducing part includes a magnet housing that accommodates a plurality of the magnets to be spaced apart from each other and is coupled to the arc chamber; and a magnet cover member that covers a pair of magnets disposed adjacent to each other among the plurality of the magnets and is coupled to the magnet housing.

In addition, the DC relay may be provided, in which the magnet cover member includes a plurality of extension parts that extend in a plate shape, are continuous with each other, cover each of the pair of magnets disposed adjacent to each other, and are coupled to the magnet housing.

### Advantageous Effects

According to the above configuration, the arc inducing part and the DC relay including the same according to the embodiment of the present disclosure can effectively induce the generated arc.

To begin with, a plurality of magnets are provided in the arc inducing part. The plurality of magnets are spaced apart from each other and are disposed to surround the arc chamber at various positions. The plurality of magnets form a magnetic field inside the arc chamber. The formed magnetic field generates a magnetic force together with the current passing through the fixed contactor and the movable contactor. At this time, the generated magnetic force is formed in a direction away from the center of the arc chamber.

The generated magnetic force can induce the arc. The arc is formed in the same direction as the magnetic force, away from the center of the arc chamber, that is, the fixed contactor and the movable contactor.

Therefore, the generated arc can be extinguished and progressed without damaging other components and discharged to the outside of the arc chamber.

In addition, according to the above configuration, the arc inducing part and the DC relay including the same according to the embodiment of the present disclosure can sufficiently secure a space for extinguishing the generated arc.

To begin with, the arc inducting part is coupled to the outside of the arc chamber. The arc inducting part includes a plurality of support walls formed to partially surround the outer circumferential surface of the arc chamber. A magnet space part is formed inside each of the plurality of support walls. The plurality of magnets are provided and each magnet is accommodated in the plurality of magnet space parts. That is, the magnets are disposed outside the arc chamber.

Accordingly, the inner space of the arc chamber can be additionally secured as much as the space occupied by the magnet. As a result, sufficient space can be secured for the arc generated inside the arc chamber to extinguish and flow.

In addition, according to the above configuration, the arc inducing part and the DC relay including the same according to the embodiment of the present disclosure can simplify manufacturing and maintenance.

The arc inducing part includes a magnet housing having an accommodation space formed therein. One side of the accommodation space can be opened, and the arc chamber can be retractably accommodated in the accommodation space through the one side. That is, the arc inducing part and the arc chamber are removably coupled to each other.

The magnet is retractably accommodated in the magnet space part formed in the magnet housing. The outer side of the magnet accommodated in the magnet housing and the magnet space part is covered by a magnet cover member. That is, in an embodiment, each component of the arc inducing part can be removably coupled to each other.

Accordingly, the arc inducing part can be manufactured and assembled for each component, and thus manufacturing efficiency can be improved. In addition, when repair or replacement of some components of the arc inducing part is required, only the components can be separated and repaired or replaced, and thus maintenance can be simplified.

In addition, according to the above configuration, the arc inducing part and the DC relay including the same according to the embodiment of the present disclosure can induce the arc in a desired direction regardless of the polarity of the external power source or load to be electrically connected thereto.

To begin with, the fixed contactor is electrically connected to the external power or load. There are a plurality of fixed contactors, and the current can be sequentially conducted and supplied to one fixed contactor, the movable contactor, and the other fixed contactor, or can be sequentially conducted and supplied to the other fixed contactor, the movable contactor, and one fixed contactor.

The magnetic field formed by the arc inducing part forms a magnetic force together with the current. The formed magnetic force is formed in a direction away from the fixed contactor and the movable contactor, regardless of the direction in which the current passes.

Therefore, the arc can be induced in a desired direction regardless of the polarity of the external power or load to be electrically connected to the DC relay.

In addition, according to the above configuration, the arc inducing part and the DC relay including the same according to the embodiment of the present disclosure can secure high design freedom and productivity.

For a start, each of the components provided in the arc inducing part can be removably coupled to each other. The coupling between the arc inducing part and the arc chamber may also be formed to be removable.

In an embodiment, the arc inducing part can be formed to have a diamond-shaped cross-section corresponding to the shape of the arc chamber. In the above embodiment, the magnets provided in the arc inducing part can be disposed in a direction different from the direction in which the plurality of fixed contactors are disposed side by side.

Accordingly, even if the arc inducing part and the DC relay are not formed in a cross-section in which the extension length in one direction is longer than the extension length in the other direction, the arc inducing part and the DC relay may achieve a sufficient induction and extinguishing effect. As a result, the design freedom and productivity of the arc inducing part and the DC relay can be improved.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating a DC relay according to an exemplary embodiment of the present disclosure.

FIG. 2 is a cross-sectional view taken along line A-A illustrating a component of the DC relay of FIG. 1.

FIG. 3 is a cross-sectional view taken along line B-B illustrating the component of the DC relay of FIG. 1.

FIG. 4 is a cross-sectional view taken along line C-C illustrating the component of the DC relay of FIG. 1.

FIG. 5 is a cross-sectional view taken along line D-D illustrating the component of the DC relay of FIG. 1.

FIG. 6 is an exploded perspective view illustrating the component of the DC relay of FIG. 1.

FIG. 7 is an exploded perspective view illustrating a frame included in the DC relay of FIG. 1.

FIG. 8 is an exploded perspective view illustrating a core part included in the DC relay of FIG. 1.

FIG. 9 is an exploded perspective view illustrating a main contact part included in the DC relay of FIG. 1.

FIG. 10 is a perspective view illustrating a sub-contact part included in the DC relay of FIG. 1.

FIG. 11 is a plan view illustrating the sub contact part of FIG. 10.

FIG. 12 is an exploded perspective view illustrating the sub contact part of FIG. 10.

FIG. 13 is a usage state diagram illustrating a process of coupling the sub contact part and the frame of FIG. 10.

FIG. 14 is a perspective view illustrating an arc chamber included in the DC relay of FIG. 1.

FIG. 15 is a plan view and a bottom view illustrating the arc chamber of FIG. 14.

FIG. 16 is an exploded perspective view illustrating the arc chamber of FIG. 14.

FIG. 17 is a perspective view illustrating an arc inducing part included in the DC relay of FIG. 1.

FIG. 18 is an exploded perspective view illustrating the arc inducing part of FIG. 17.

FIG. 19 is an exploded plan view illustrating the arc inducing part of FIG. 17.

FIG. 20 is a plan cross-sectional view illustrating the arc inducing part of FIG. 17.

FIG. 21 is a cross-sectional view taken along line C-C illustrating an arrangement structure and an insulating distance between a fixed contact and an auxiliary contact included in the DC relay according to an embodiment of the present disclosure.

FIG. 22 is a cross-sectional view taken along line C-C illustrating an arc extinguish space formed inside an arc chamber included in the DC relay according to an embodiment of the present disclosure.

FIG. 23 is a cross-sectional view taken along line B-B illustrating a coupling relationship between a sub contact part and an arc chamber included in the DC relay and an arc extinguish space formed inside the arc chamber according to an embodiment of the present disclosure.

FIGS. 24 and 25 are cross-sectional views taken along line B-B illustrating examples of arc extinguish paths formed inside the DC relay according to an embodiment of the present disclosure.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

Terms and words used in the present specification and claims should not be construed as limited to their usual or dictionary definition, and they should be interpreted as a meaning and concept consistent with the technical idea of the present disclosure based on the principle that inventors may appropriately define the terms and concept in order to describe their own disclosure in the best way.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

In the following description, in order to clarify the features of the present invention, descriptions of some components may be omitted.

The term “electrically connection” used in the following description means that two or more members are connected to transmit an electrical signal or current. In an embodiment, the electric-current-conducting may be formed in a wired form by a wire member or the like or in a wireless form such as RFID, Bluetooth, Wi-Fi or the like.

The term “communication” used in the following description means that two or more members are connected to each other so as to be in fluid communication. In one embodiment, the communication may be formed by a space formed inside the two or more members. Alternatively, the communication may be formed by a pipe, conduit, hose, or other member.

As used in the following description, the terms “upper side”, “lower side”, “front side”, “rear side”, “left side” and “right side” will be understood with reference to the coordinate system shown throughout the accompanying drawings.

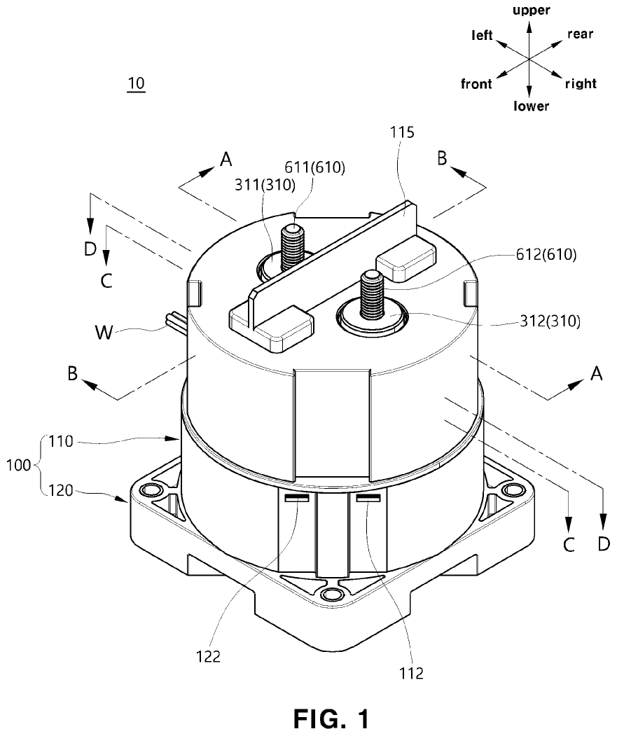

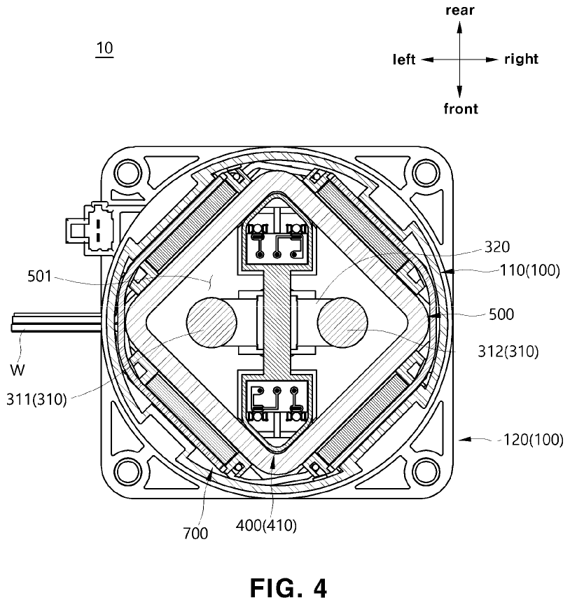

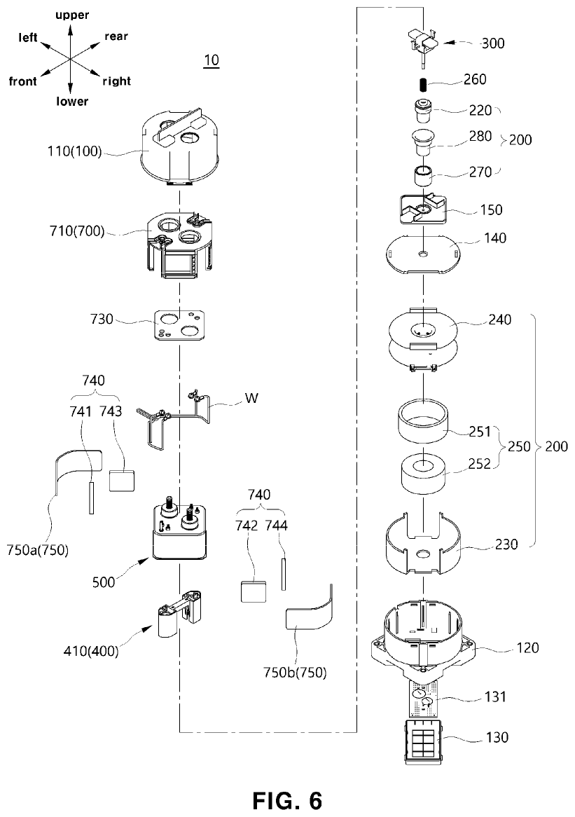

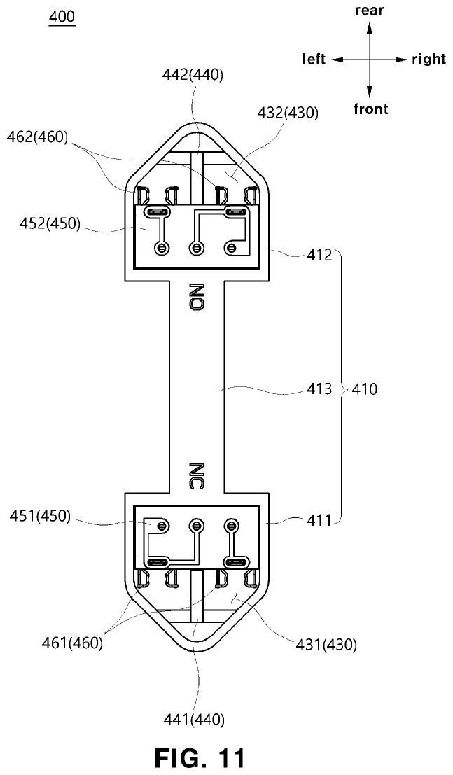

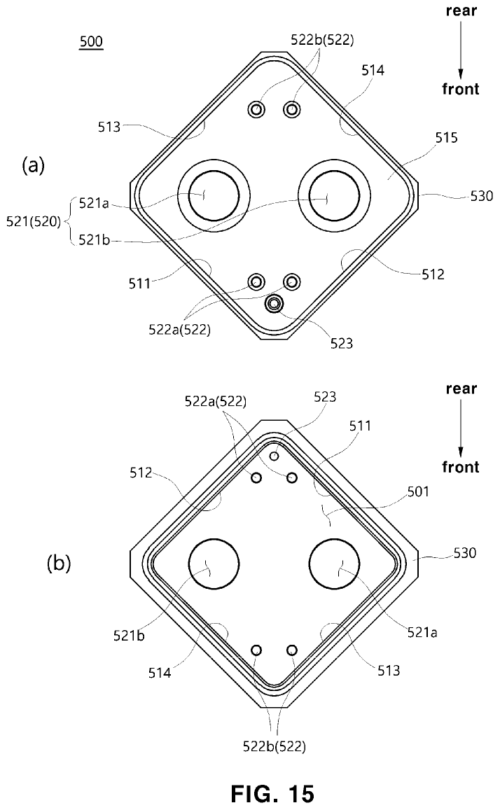

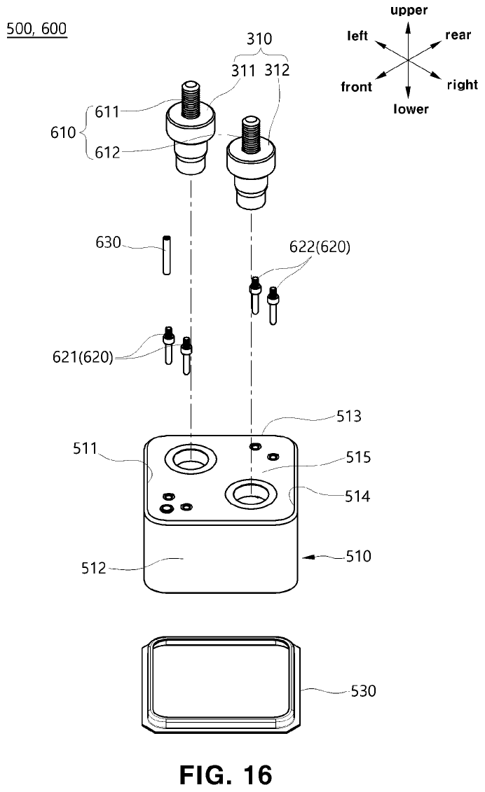

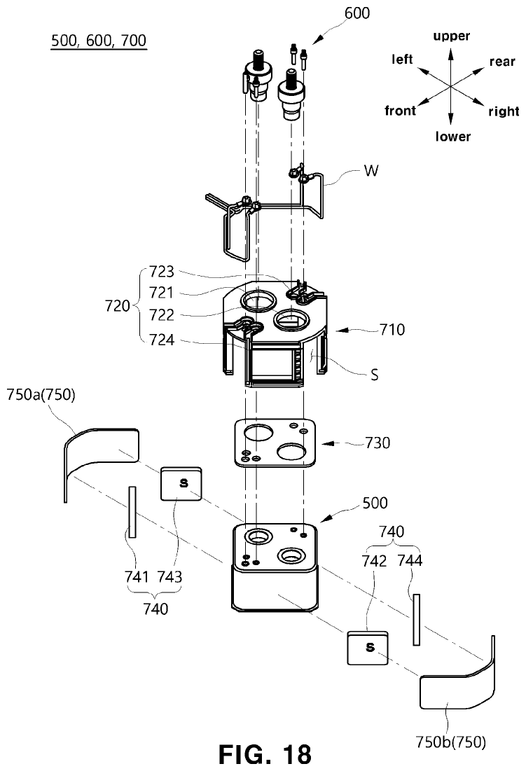

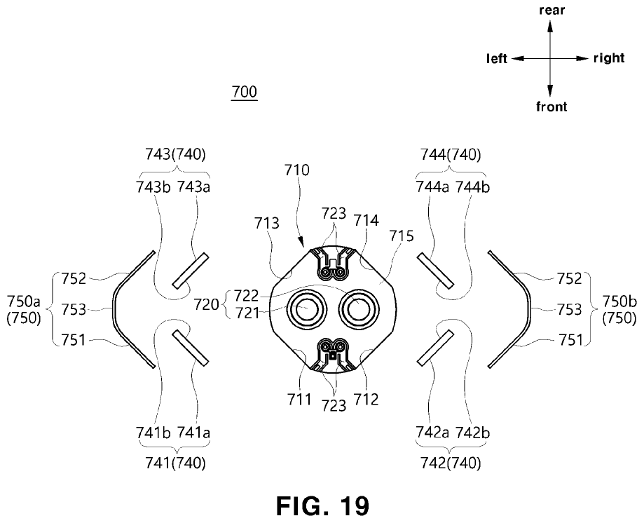

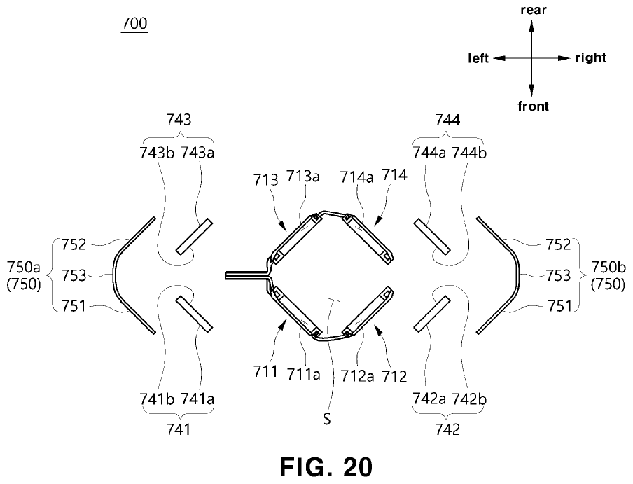

Referring to FIGS. 1 to 20, a DC relay 10 according to an embodiment of the present disclosure is shown.

The DC relay 10 according to an embodiment of the present disclosure may secure sufficient space to extinguish an arc generated when the DC power is turned on or off through a shape of the arc chamber 500.

In addition, a sub contact part 400 to which power is applied for the operation of the DC relay 10 is sufficiently spaced apart from a main contact part 300, so that a distance for insulating can be secured.

Furthermore, an arrangement structure of a magnet and a direction of a magnetic field formed thereby are varied, so that a movement path of the arc generated when the DC power is turned on or off may be formed in various ways.

In the illustrated embodiment, the DC relay 10 includes a frame 100, a core part 200, the main contact part 300, the sub contact part 400, the arc chamber 500, a terminal part 600, and an arc inducing part 700.

The frame 100 forms the outer shape of the DC relay 10. A space is formed inside the frame 100, and various components of the DC relay 10 may be mounted therein. In the illustrated embodiment, the inner space of the frame 100 accommodates the core part 200, the main contact part 300, the sub contact part 400, the arc chamber 500, the terminal part 600, and the arc inducing part 700.

Some of the above components may be disposed to be exposed outside the frame 100. Specifically, a fixed contactor 310 of the main contact part 300, a main terminal 610 of the terminal part 600, and the like are exposed to the outside the frame 100.

The inner space of the frame 100 is electrically connected to the outside. The main terminal 610 and the main contact part 300 electrically connected thereto may be electrically connected to an external power source and load, respectively, by a separate conductive wire member (not shown). In addition, the sub contact part 400, which moves a movable core 220 by applying current to a coil 250, is connected to the external power source by a conductor member W.

The inner space of the frame 100 communicates with the outside. The arc generated when the fixed contactor 310 and a movable contactor 320 are in contact or spaced apart from each other may be extinguished and discharged to the outside.

The frame 100 may be formed of an insulating material. It is to prevent the current applied during operation of the DC relay 10 from leaking randomly to the outside. In addition, the frame 100 may be formed of a high-strength material. This is to prevent damage caused by the arc generated internally or in the external environment where the DC relay 10 is installed. In an embodiment, the frame 100 may be formed of a synthetic resin material such as reinforced plastic.

The frame 100 may form an outer shape of the DC relay 10 and may be formed in any shape capable of mounting various components therein. In the illustrated embodiment, the upper side of the frame 100 is circular in cross-section and has a cylindrical shape extending in the vertical direction. Additionally, the lower side of the frame 100 is formed along the height direction to have a circular cross-section on the upper side and a square cross-section on the lower side.

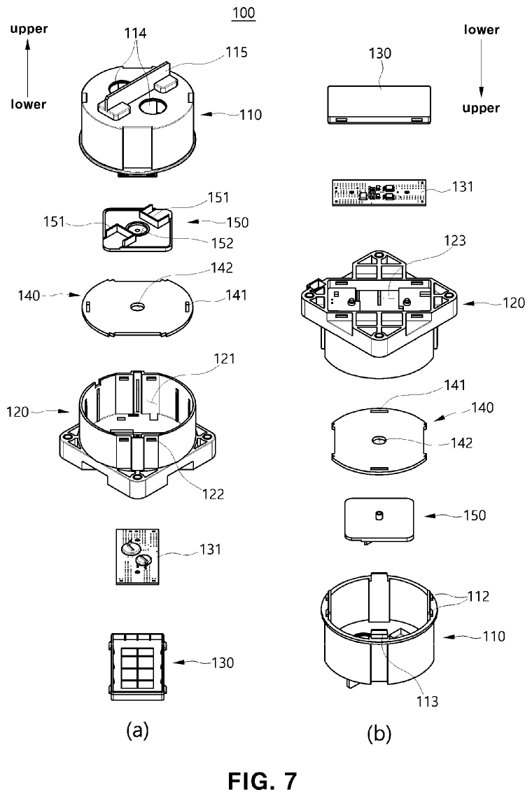

In an embodiment shown in FIG. 7, the frame 100 includes an upper frame 110, a lower frame 120, a PCB frame 130, a supporting plate 140, and a first insulating plate 150.

The upper frame 110 forms a portion of the frame 100 in the height direction, the upper side in the illustrated embodiment. The upper frame 110 is coupled to the lower frame 120. In an embodiment, the upper frame 110 may be removably coupled to the lower frame 120. In an embodiment, The upper frame 110 may be coupled to the lower frame 120. In the above embodiment, the space formed inside the upper frame 110 and the lower frame 120 is easily opened, and maintenance may be facilitated.

The upper frame 110 is formed to have a predetermined shape. In the illustrated embodiment, the upper frame 110 has a cylindrical shape with a circular cross-section and a height in the vertical direction.

The DC relay 10 according to the embodiment of the present disclosure may achieve various effects by modifying the shape of the arc chamber 500 while maintaining the shape of the upper frame 110 in a cylindrical shape. This will be described later in detail.

In the illustrated embodiment, the upper frame 110 includes an upper space 111, a coupling protrusion 112, a support protrusion 113, an upper opening 114 and an upper separation wall 115.

The upper space 111 is a space formed inside the upper frame 110. Some of the components of the DC relay 10 may be accommodated in the upper space 111. In the illustrated embodiment, the upper space 111 accommodates the main contact part 300, the sub contact part 400, the arc chamber 500, the terminal part 600, and the arc inducing part 700.

The upper space 111 communicates with the outside. The arc generated inside the arc chamber 500 may be extinguished and discharged to the outside.

The upper space 111 is electrically connected to the outside. The fixed contactor 310 of the main contact part 300 may be electrically connected to the outside by the main terminal 610 electrically connected thereto. In addition, the sub contact part 400 may be electrically connected to the outside by the conductive wire member W.

The upper space 111 is partially communicated with the lower space 121. Specifically, the upper space 111 is physically partitioned by the support plate 140 and the first insulating plate 150. At this time, the shaft 360 is accommodated in the hollow formed inside the support plate 140 and the inside of the first insulating plate 150 so that it may be raised and lowered, it may be said that the upper space 111 partially communicates with the lower space 121.

The upper space 111 may be formed in a shape corresponding to the shape of the upper frame 110. In the illustrated embodiment, since the upper frame 110 has a cylindrical shape, the upper space 111 formed therein may also be formed as a cylindrical space with a circular cross-section and a height in the vertical direction.

The coupling protrusion 112 and the support protrusion 113 are provided on the outer circumferential surface of the upper frame 110 surrounding the upper space 111 radially outside.

The coupling protrusion 112 and the support protrusion 113 are parts where the upper frame 110 is removably coupled to the lower frame 120. The coupling protrusion 112 and the support protrusion 113 are located on the outer circumferential surface of the upper frame 110. The coupling protrusion 112 and the support protrusion 113 are provided at a corner, extending downward in the illustrated embodiment in a direction toward the lower frame 120.

The coupling protrusion 112 is removably coupled to a coupling groove 122 provided in the lower frame 120. As can be seen from the name, the coupling protrusion 112 may be formed to protrude and may be fitted or snapped into the coupling groove 122. In the illustrated embodiment, the coupling protrusion 112 protrudes radially outward, and extends a predetermined length along the outer circumferential direction of the upper frame 110.

A plurality of coupling protrusions 112 may be provided. The plurality of coupling protrusions 112 may be disposed to be spaced apart from each other along the outer circumferential direction of the upper frame 110. In the embodiment shown in FIG. 7, two coupling protrusions 112 are provided and disposed to be spaced apart from each other along the outer circumferential direction of the upper frame 110.

The coupling protrusion 112 may be provided in a plurality of pairs. A plurality of pairs of coupling protrusions 112 may be disposed to be spaced apart from each other along the outer circumferential direction of the upper frame 110. In the embodiment shown in FIG. 7, the coupling protrusion 112 is provided in two pairs and disposed to be spaced apart from each other along the outer circumferential direction of the upper frame 110.

In an embodiment, each pair of coupling protrusions 112 may be disposed at a predetermined angle with respect to the center of the upper frame 110. In the illustrated embodiment, the predetermined angle is 180°.

The support protrusion 113 is positioned between each pair of coupling protrusions 112 along the outer circumferential direction of the upper frame 110.

The support protrusion 113 is a portion where the upper frame 110 is coupled to the support plate 140. The support protrusion 113 is removably coupled to the support groove 141 formed in the support plate 140. As can be seen from the name, the support protrusion 113 is formed to have a predetermined shape and may be snap-coupled to the support groove 141.

That is, in the illustrated embodiment, the support protrusion 113 has a cross-sectional area in a direction toward the lower frame 120 that is smaller than a cross-sectional area in a direction opposite to the lower frame 120. The outer circumferential surface of the support protrusion 113 may be formed to extend inclined toward the radially outer side along the direction opposite to the lower frame 120.

A plurality of support protrusions 113 may be provided. The plurality of support protrusions 113 may be disposed to be spaced apart from each other along the outer circumferential direction of the upper frame 110. In the embodiment shown in FIG. 7, two support protrusions 113 are provided and disposed to be spaced apart from each other along the outer circumferential direction of the upper frame 110. In this case, the support protrusion 113 may be disposed to face each other with the upper space 111 interposed therebetween.

In the above embodiment, the plurality of support protrusions 113 may be disposed at a predetermined angle with respect to the center of the upper frame 110. In the illustrated embodiment, the predetermined angle is 180°.

That is, in the illustrated embodiment, the coupling protrusions 112 and support protrusions 113 are alternately arranged along the outer periphery of the upper frame 110.

The upper opening 114 is a portion in which the upper space 111 communicates with the outside. The upper opening 114 is formed through one side of the upper frame 110 surrounding the upper space 111. In the illustrated embodiment, the upper opening 114 is formed through the upper surface of the upper frame 110.

A plurality of upper openings 114 may be formed. A plurality of fixed contactors 310 may be respectively penetratingly coupled to the plurality of upper openings 114. In the illustrated embodiment, two upper openings 114 are provided, and the first fixed contactor 311 and the second fixed contactor 312 are respectively penetratingly coupled.

The upper opening 114 communicates with the upper space 111 and the outside and may be of any shape through which the fixed contact 310 may be coupled through. In the illustrated embodiment, the upper opening 114 is a disk-shaped space with a circular cross-section and a thickness in the vertical direction.

An upper separation wall 115 is provided between the plurality of upper openings 114.

The upper separation wall 115 physically partitions the plurality of upper openings 114 and blocks the electrical conduction between the fixed contactors 310 accommodated in each upper opening 114 and the main terminals 610 respectively electrically connected to the fixed contactors 310.

The upper separation wall 115 may be formed to extend in one direction. In the illustrated embodiment, the upper separation wall 115 extends in the front-rear direction and is positioned between the plurality of upper openings 114 disposed to be spaced apart in the left-right direction.

The upper separation wall 115 may be formed to have a predetermined height, that is, a length in the vertical direction in the illustrated embodiment. The height of the upper separation wall 115 may be any height capable of electrically separating the first main terminal 611 and the second main terminal 612.

The lower frame 120 forms the remaining portion of the frame 100 in the height direction, that is, a lower side in the illustrated embodiment. The lower frame 120 is coupled to the upper frame 110. In an embodiment, the lower frame 120 may be removably coupled to the upper frame 110.

The lower frame 120 is formed to have a predetermined shape. In the illustrated embodiment, one side of the lower frame 120 facing the upper frame 110, that is, the upper side, has a cylindrical shape with a circular cross-section and a height in the vertical direction, corresponding to the shape of the cross-section of the upper frame 110.

Additionally, in the illustrated embodiment, the remaining side, that is, the lower side, of the lower frame 120 opposite to the upper frame 110 is shaped like a square pillar with a rectangular cross-section and a height in the vertical direction. In the above example, the length of one side of the lower cross-section of the lower frame 120 may be equal to the diameter of the upper cross-section of the lower frame 120.

Therefore, the lower portion of the lower frame 120 is formed to have a larger cross-sectional area than the upper portion, so that the DC relay 10 may be stably supported.

In the illustrated embodiment, the lower frame 120 includes a lower space 121, a coupling groove 122, and a PCB accommodation part 123.

The lower space 121 is a space formed inside the lower frame 120. Some of the remaining components of the DC relay 10 may be accommodated in the lower space 121. In the illustrated embodiment, a portion of the core part 200 and the main contact part 300 are accommodated in the lower space 121.

The lower space 121 is electrically connected to the outside. The coil 250 of the core part 200 may receive current for forming a magnetic field from the sub contact part 400.

The lower space 121 is partially communicated with the upper space 111. The shaft 360 of the main contact part 300 may be partially accommodated in the lower space 121 and the upper space 111, respectively, and may be provided to be lifted up and down.

The lower space 121 may be formed in a shape corresponding to the shape of the lower frame 120. In the illustrated embodiment, since the upper portion of the lower frame 120 has a cylindrical shape, the lower space 121 formed therein may also be formed as a cylindrical space with a circular cross-section and a height in the vertical direction.

A coupling groove 122 is formed on the outer circumferential surface of the lower frame 120 surrounding the lower space 121 from the radially outer side.

The coupling groove 122 is a portion where the lower frame 120 is removably coupled to the upper frame 110. The coupling groove 122 is formed on the outer circumferential surface of the lower frame 120. In the illustrated embodiment, the coupling groove 122 is located biased on the upper side of the lower frame 120, that is, on one side facing the upper frame 110.

As can be seen from the name, the coupling groove 122 may be recessed or penetrated to allow the coupling protrusion 112 to be removably accommodated. The coupling protrusion 112 may be fitted or snap-coupled to the coupling groove 122 as described above.

The coupling groove 122 may be formed to correspond to the shape of the coupling protrusion 112. In the illustrated embodiment, the coupling protrusion 112 extends along the outer circumferential direction of the upper frame 110, and the coupling groove 122 may also extend along the outer circumferential direction of the lower frame 120.

The coupling groove 122 may be formed to correspond to the number of coupling protrusions 112. In the illustrated embodiment, two coupling protrusions 112 are provided to be spaced apart along the outer circumferential direction of the upper frame 110, and the coupling grooves 122 are also formed to be spaced apart along the outer circumferential direction of the lower frame 120.

The coupling groove 122 may be provided in a plurality of pairs. The plurality of pairs of coupling grooves 122 may be arranged according to the arrangement method of the plurality of pairs of coupling protrusions 112. In the embodiment shown in FIG. 7, two pairs of coupling grooves 122 are provided and disposed to be spaced apart from each other along the outer circumferential direction of the lower frame 120.

At this time, each pair of coupling grooves 122 may be arranged at a predetermined angle with respect to the center of the lower frame 120. In the illustrated embodiment, the predetermined angle is 180°.

A PCB accommodation part 123 is formed on one side of the lower frame 120 opposite to the upper frame 110, that is, on the lower side in the illustrated embodiment.

The PCB accommodation part 123 is a space where the PCB 131 provided to control the DC relay 10 is accommodated. The PCB accommodation part 123 is electrically connected to the outside, so that current and electrical control signals for controlling the PCB 131 may be input. Additionally, the PCB accommodation part 123 is physically spaced apart from the lower space 121.

In other words, in the illustrated embodiment, the PCB accommodation part 123 is physically spaced apart from the lower space 121 by a surface surrounding the lower space 121 from the lower side.

The PCB accommodation part 123 may be any shape capable of accommodating the PCB frame 130. In the illustrated embodiment, the PCB accommodation part 123 is formed to have a rectangular cross-section in which a length of a pair of sides extending in one direction is longer than a length of a pair of sides extending in the other direction.

The PCB accommodation part 123 may be closed by the PCB frame 130.

The PCB frame 130 is coupled to the lower frame 120 to stably support the PCB 131. The PCB frame 130 is accommodated in the PCB accommodation part 123 of the lower frame 120. In an embodiment, the PCB frame 130 may be removably coupled to the PCB accommodation part 123.

The PCB frame 130 may be any shape capable of supporting the PCB 131 by being coupled to the PCB accommodation part 123. In the illustrated embodiment, the PCB frame 130 is formed to have a rectangular cross-section in which the extension length of a pair of surfaces facing each other is longer than the length of the other pair of faces. The shape of the PCB frame 130 may change depending on the shapes of the PCB accommodation part 123 and the PCB 131.

A plurality of through holes may be formed inside the PCB frame 130. Ribs are extended between the plurality of through holes to stably support the PCB 131.

The PCB 131 is accommodated inside the PCB frame 130. One surface of the PCB 131 facing the upper frame 110, that is, the upper surface in the illustrated embodiment is surrounded by a surface surrounding the PCB accommodation part 123 from the upper side. The other surface of the PCB 131 opposite to the upper frame 110, that is, the lower surface in the illustrated embodiment, are surrounded by the PCB frame 130.

The PCB 131 is connected to other components. In an embodiment, the PCB 131 may be electrically connected to the main contact part 300.

Since the process of controlling other components of the DC relay 10 by the PCB 131 is a well-known technology, detailed description will be omitted.

The support plate 140 is coupled to the upper frame 110 and the lower frame 120, respectively, to physically separate the upper space 111 and the lower space 121. In this case, a support through hole 142 is formed through the inside of the support plate 140 to function as a passage for the shaft 360 to be raised and lowered.

The support plate 140 may be any shape that can be coupled to the upper frame 110 and the lower frame 120, respectively, to form the DC relay 10. In the illustrated embodiment, the support plate 140 includes a pair of straight edges facing each other and another pair of edges extending roundly from each end of the pair of edges.

As can be seen from the name, the support plate 140 is provided in a plate shape with a predetermined thickness. Accordingly, the size of the space occupied by the support plate 140 inside the DC relay 10 may be reduced.

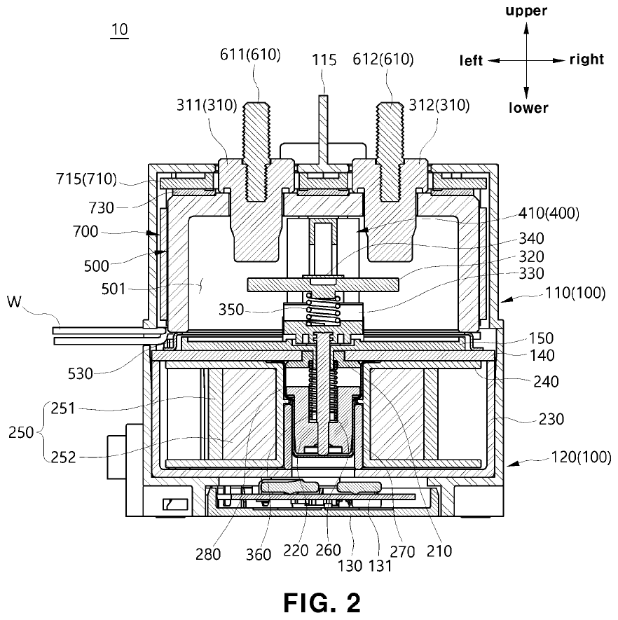

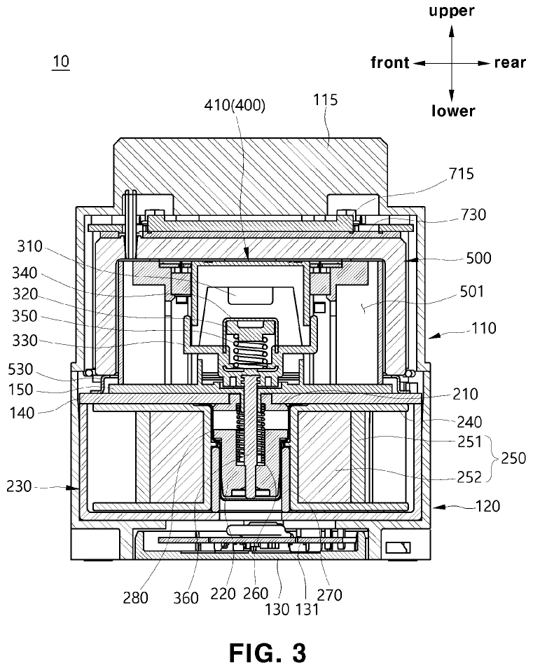

In the embodiment shown in FIGS. 2 and 3, the support plate 140 is accommodated in the lower space 121. The first insulating plate 150, the main contact part 300, the sub contact part 400, the arc chamber 500, the terminal part 600, and the arc induction part 700 are located on the upper side of the support plate 140. The core part 200 is located on the lower side of the support plate 140.

In the illustrated embodiment, the support plate 140 includes the support groove 141 and the support through hole 142.

The support groove 141 is a space in which the support protrusion 113 of the upper frame 110 is accommodated. The support protrusion 113 may be removably coupled to the support groove 141. In an embodiment, the support protrusion 113 may be snap-coupled to the support groove 141 as described above.

The support groove 141 may be formed in a shape corresponding to the shape of the support protrusion 113. In the illustrated embodiment, the support groove 141 extends in the front-rear direction and is formed through the vertical direction.

A plurality of support grooves 141 may be formed. The plurality of support grooves 141 may be disposed at different positions of the support plate 140. In the illustrated embodiment, a plurality of support grooves 141 are disposed adjacent to the other pair of edges. The arrangement method of the support groove 141 may be changed depending on the arrangement method of the support protrusion 113.

The support through hole 142 is a hollow formed inside the support plate 140. The support through hole 142 is formed through the support plate 140 in a thickness direction, that is, in a vertical direction in the illustrated embodiment. The shaft 360 of the main contact part 300 is coupled through the support through hole 142 to be lifted up and down.

The support through hole 142 may be any shape that allows the shaft 360 to be coupled to be lifted up and down. In the illustrated embodiment, the shaft 360 has a circular cross-section and has a cylindrical shape extending in the vertical direction, and the support through hole 142 is also formed to have a circular cross-section. In the above embodiment, the center of the support through hole 142 may be formed to have the same central axis as the center of the holder through hole 152, the core part 200, and the shaft 360.

The first insulating plate 150 is stacked on the upper side of the support plate 140.

The first insulating plate 150 physically and electrically separates the upper space 111 and the lower space 121. The components accommodated in the upper space 111 and the components accommodated in the lower space 121 do not have an electrical effect on each other by the first insulating plate 150.

The first insulating plate 150 is stacked on the support plate 140. In the embodiment shown in FIGS. 2 and 3, the first insulating plate 150 is accommodated in the lower space 121. The main contact part 300, the sub contact part 400, the arc chamber 500, the terminal part 600, and the arc induction part 700 are located on the upper side of the first insulating plate 150. The support plate 140 and the core part 200 are located on the lower side of the first insulating plate 150.

The first insulating plate 150 may be formed of any material that can physically separate the upper space 111 and the lower space 121. In one embodiment, the first insulating plate 150 may be formed of rubber or ceramic material.

In the illustrated embodiment, the first insulating plate 150 includes the holder support part 151 and the holder through hole 152.

The holder support part 151 supports the contact holder 401 of the sub contact part 400. As will be described later, the contact holder 401 is accommodated inside the arc chamber 500 and extends toward the lower frame 120. The holder support part 151 supports the body part 410, specifically the first leg 411 and the second leg 412 of the contact holder 401, to prevent any oscillation of the contact holder 401.

The holder support 151 may include a space for accommodating the first leg 411 and the second leg 412 and a partition wall surrounding the space. In the illustrated embodiment, the holder support part 151 includes a space in which one side facing the radially outside is opened and a partition wall surrounding the space from the other side facing the radially inside. The partition wall may extend by a sufficient height to stably support the first leg 411 and the second leg 412.

Therefore, when an impact occurs along with an arc, the first leg 411 and the second leg 412 are moved radially outward a predetermined distance and the impact may be buffered. Additionally, when no arc is generated, the first rack 411 and the second rack 412 may be stably supported by the partition walls.

A plurality of holder support parts 151 may be provided. The plurality of holder support parts 151 may be disposed at different positions, and may accommodate and support the first leg 411 and the second leg 412, respectively. In the illustrated embodiment, two holder support parts 151 are provided, and are located at the front side and the rear side, respectively. In the above embodiment, the two holder support parts 151 may be disposed to face each other with the holder through hole 152 interposed therebetween.

The holder through hole 152 is a hollow formed inside the first insulating plate 150. The holder through hole 152 is formed through the first insulating plate 150 in the thickness direction of the first insulating plate 150, that is, in the up-down direction in the illustrated embodiment. The shaft 360 of the main contact part 300 is coupled through the holder through hole 152 to be lifted up and down.

The holder through hole 152 may be any shape that allows the shaft 360 to be coupled to be lifted up and down. In the illustrated embodiment, the holder through hole 152 is formed to have a circular cross-section like the shaft 360. In the above embodiment, the center of the holder through hole 152 may be formed to have a central axis such as the support through hole 142, the core part 200, and the shaft 360, as described above.

The core part 200 is electrically connected to the sub contact part 400 and is raised and lowered inside the DC relay 10. As the core part 200 is raised and lowered, the movable contactor 320 of the main contact part 300 is also raised and lowered, so that the main contact part 300 may be connected to an external power source and load.

The core part 200 is accommodated in the inner space of the frame 100. Specifically, the core part 200 is accommodated in the lower space 121 to be capable of being lifted up and down.

The core part 200 is electrically connected to the outside. Specifically, the core part 200 is electrically connected to an external control power (not shown) through the sub contact part 400 and the conductive member W. The core part 200 may be operated according to a control signal and current applied from the external control power (not shown).

The core part 200 is connected to the main contact part 300. As the core part 200 is raised and lowered, the shaft 360 of the main contact part 300 and the movable contactor 320 coupled thereto are raised and lowered together to electrically connect the movable contactor 320 and the fixed contactor 310. Accordingly, the DC relay 10 may be electrically connected to external power source and load.

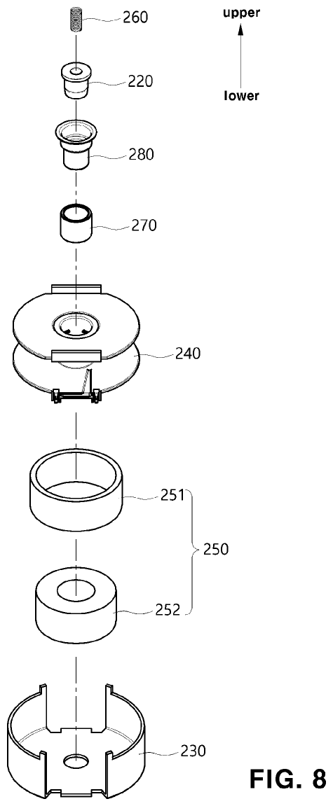

In the embodiment shown in FIG. 8, the core part 200 includes a stationary core 210, a movable core 220, a yoke 230, a bobbin 240, a coil 250, a core spring 260, a yoke ring 270, and a cylinder 280.

The stationary core 210 is magnetized by a magnetic field generated in the coil 250 to generate an electromagnetic attraction force. By the electromagnetic attraction force, the movable core 220 is moved toward the stationary core 210 (upward direction in FIGS. 2 and 3).

The stationary core 210 is not moved. That is, the stationary core 210 is fixedly coupled to the support plate 140 and the cylinder 280.

The stationary core 210 may be provided in any form capable of generating electromagnetic force by being magnetized by a magnetic field. In an embodiment, the stationary core 210 may be provided as a permanent magnet or an electromagnet and the like.

The stationary core 210 is partially accommodated in an upper space inside the cylinder 280. In addition, the outer circumference of the stationary core 210 is in contact with the inner circumference of the cylinder 280.

The stationary core 210 is located between the support plate 140 and the movable core 220.

A through hole (not shown) is formed at the center of the stationary core 210. The shaft 360 is through-coupled to the through hole (not shown) so as to be movable up and down.

The stationary core 210 is positioned to be spaced apart from the movable core 220 by a predetermined distance. Accordingly, the distance that the movable core 220 may be moved toward the stationary core 210 may be limited to the predetermined distance. Accordingly, the predetermined distance may be defined as “travel distance of the movable core 220”.

One end of the core spring 260, that is, the upper end in the illustrated embodiment, is in contact with the lower side of the stationary core 210. When the stationary core 210 is magnetized and the movable core 220 is moved upward, the core spring 260 is compressed and restoring force is stored.

Accordingly, when the application of the control power is released and the magnetization of the stationary core 210 is terminated, the movable core 220 may be returned to downward again by the restoring force.

When the control power is applied, the movable core 220 is moved toward the stationary core 210 by electromagnetic attraction force generated by the stationary core 210.

As the movable core 220 is moved, the shaft 360 coupled to the movable core 220 is moved in the direction toward the stationary core 210, that is, upward in the illustrated embodiment. In addition, as the shaft 360 is moved, the movable contactor 320 coupled to the shaft 360 is moved upward.

Accordingly, the fixed contactor 310 and the movable contactor 320 may be brought into contact with each other so that the DC relay 10 may be electrically connected to the external power source or load.

The movable core 220 may be provided in any form capable of being subjected to attraction by electromagnetic force. In an embodiment, the movable core 220 may be formed of a magnetic material or may be provided as a permanent magnet or an electromagnet and the like.

The movable core 220 is accommodated inside the cylinder 280. In addition, the movable core 220 may be moved in the longitudinal direction of the cylinder 280 inside the cylinder 280, that is, in a vertical direction in the illustrated embodiment.

Specifically, the movable core 220 may be moved in a direction toward the stationary core 210 and in a direction away from the stationary core 210.

The movable core 220 is coupled to the shaft 360. The movable core 220 may be moved integrally with the shaft 360. When the movable core 220 is moved upward or downward, the shaft 360 is also moved upward or downward. Accordingly, the movable contactor 320 is also moved upward or downward.

The movable core 220 is located below the stationary core 210. The movable core 220 is spaced apart from the stationary core 210 by a predetermined distance. The predetermined distance is the distance at which the movable core 220 may be moved in the vertical direction as described above.

The movable core 220 is formed extending in the longitudinal direction. Inside the movable core 220, a hollow part extending in the longitudinal direction is formed recessed by a predetermined distance. The lower part of the core spring 260 and the shaft 360 coupled through the core spring 260 are partially accommodated in the hollow part.

A through hole is formed through the lower side of the hollow part in the longitudinal direction. The hollow part and the through hole communicate with each other. A lower end of the shaft 360 inserted into the hollow part may progress toward the through hole.

At the lower end of the movable core 220, a space part is formed recessed by a predetermined distance. The space part communicates with the through hole. The lower head portion of the shaft 360 is located in the space part.

The yoke 230 forms a magnetic circuit as a control power is applied. The magnetic circuit formed by the yoke 230 may be configured to control the direction of the magnetic field formed by the coil 250.

Accordingly, when the control power is applied, the coil 250 may generate a magnetic field in a direction in which the movable core 220 is moved toward the stationary core 210. The yoke 230 may be formed of a conductive material capable of energizing electric current.

The yoke 230 is accommodated inside the lower space 121. The yoke 230 surrounds the coil 250. The coil 250 may be accommodated inside the yoke 230 to be spaced apart from the inner circumferential surface of the yoke 230 by a predetermined distance.

The bobbin 240 is accommodated inside the yoke 230. That is, the yoke 230, the coil 250, and the bobbin 240 around which the coil 250 is wound are sequentially arranged in a radially inward direction from the outer circumference of the lower frame 120.

The upper side of the yoke 230 is in contact with the support plate 140. In addition, the outer circumference of the yoke 230 may be positioned to contact the inner circumference of the lower frame 120 or to be spaced apart from the inner circumference of the lower frame 120 by a predetermined distance.

The coil 250 is wound on the bobbin 240. The bobbin 240 is accommodated inside the yoke 230.

The bobbin 240 may include a flat plate-shaped upper portion and a flat plate-shaped lower portion, and a cylindrical pillar part extending in a longitudinal direction and connecting the upper portion and the lower portion. That is, the bobbin 240 has a reel shape.

An upper portion of the bobbin 240 is in contact with a lower side of the support plate 140. The coil 250 is wound around the pillar part of the bobbin 240. The thickness of the coil 250 to be wound may be equal to or smaller than the diameters of the upper and lower portions of the bobbin 240.

A hollow part extending in the longitudinal direction is formed through the pillar part of the bobbin 240. The cylinder 280 may be accommodated in the hollow part. The pillar part of the bobbin 240 may be arranged to have the same central axis as the stationary core 210, the movable core 220, and the shaft 360.

The coil 250 generates a magnetic field by an applied control power. The stationary core 210 may be magnetized by a magnetic field generated by the coil 250, and an electromagnetic attraction force may be applied to the movable core 220.

The coil 250 is wound around the bobbin 240. Specifically, the coil 250 is wound around the pillar part of the bobbin 240 and stacked radially outward of the pillar part. The coil 250 is accommodated inside the yoke 230.

When the control power is applied, the coil 250 generates a magnetic field. In this case, the intensity or direction or the like of the magnetic field generated by the coil 250 may be controlled by the yoke 230. The stationary core 210 is magnetized by the magnetic field generated by the coil 250.

When the stationary core 210 is magnetized, the movable core 220 is subjected to an electromagnetic force, that is, an attraction force, in a direction toward the stationary core 210. Accordingly, the movable core 220 is moved in a direction toward the stationary core 210, that is, upward in the illustrated embodiment.

A plurality of through holes 250 may be provided. The plurality of coils 250 may be configured to form a magnetic field according to different control signals applied from the sub contact part 400. In the illustrated embodiment, two coils 250 are provided, including a trip coil 251 and a holding coil 252.

The trip coil 251 and the holding coil 252 may be arranged to be stacked in the radiation direction. In the illustrated embodiment, the trip coil 251 is formed to surround the holding coil 252 radially outside the holding coil 252. For this purpose, a hollow is formed through the inside of the trip coil 251 to accommodate the holding coil 252.

The holding coil 252 is located radially inside the trip coil 251. The holding coil 252 is formed to surround the cylinder 280 and the movable core 220, the core spring 260, and the yoke ring 270 accommodated therein from the radially outer side. To this end, a hollow is formed through the inside of the holding coil 252.

The core spring 260 provides a restoring force for returning the movable core 220 to its original position when application of the control power is released after the movable core 220 is moved toward the stationary core 210.

As the movable core 220 is moved toward the stationary core 210, the core spring 260 is compressed and stores a restoring force. At this time, the stored restoring force is preferably smaller than the electromagnetic attraction force applied to the movable core 220 after the stationary core 210 is magnetized. This is to prevent the movable core 220 from being arbitrarily returned to its original position by the core spring 260 while the control power is applied.

When the application of the control power is released, the movable core 220 receives a restoring force by the core spring 260. Of course, gravity due to empty weight of the movable core 220 may also act on the movable core 220. Accordingly, the movable core 220 may be moved in a direction away from the stationary core 210 and returned to its original position.

The core spring 260 may be provided in any shape capable of deforming, storing restoring force, returning to its original shape, and transmitting the restoring force to the outside. In an embodiment, the core spring 260 may be provided as a coil spring.

A shaft 360 is coupled through the core spring 260. The shaft 360 may be moved in the vertical direction regardless of the shape deformation of the core spring 260 in a state in which the core spring 260 is coupled.

The core spring 260 is accommodated in a hollow part formed recessed on the upper side of the movable core 220. In addition, one end of the core spring 260 facing the stationary core 210, that is, the upper end in the illustrated embodiment, is accommodated in a hollow part formed recessed in the lower side of the stationary core 210.

The yoke ring 270 is coupled to the bobbin 240 and the cylinder 280, respectively, to maintain the position of the cylinder 280.

The yoke ring 270 is accommodated in a hollow formed inside the bobbin 240. A hollow may be formed inside the yoke ring 270 so that the cylinder 280 and other components accommodated in the cylinder 280 may pass through.

In other words, in the embodiment shown, the yoke ring 270 is located between the bobbin 240 and the cylinder 280 in the radial direction.

The cylinder 280 accommodates the stationary core 210, the movable core 220, the core spring 260, and the shaft 360. The movable core 220 and the shaft 360 may be moved upward and downward direction inside the cylinder 280.

The cylinder 280 is located in the hollow part formed in the pillar part of the bobbin 240. The upper end of the cylinder 280 is in contact with the lower surface of the support plate 140.

The side surface of the cylinder 280 is in contact with the inner circumferential surface of the pillar part of the bobbin 240. An upper opening of the cylinder 280 may be sealed by the stationary core 210. The lower surface of the cylinder 280 may be in contact with the inner surface of the lower frame 120.

The main contact part 300 allows or blocks electric current according to the operation of the core part 200. Specifically, the movable contactor 320 of the main contact part 300 may be moved to contact or spaced apart from the fixed contactor 310 to allow or block electric current.

The main contact part 300 is accommodated in the upper space 111. The main contact part 300 may be electrically and physically spaced apart from the core part 200 by the insulating plate 150 and the support plate 140.

The main contact portion 300 is accommodated inside the arc chamber 500. The arc generated during the operation of the main contact part 300 is extinguished by the arc chamber 500 and may be discharged to the outside.

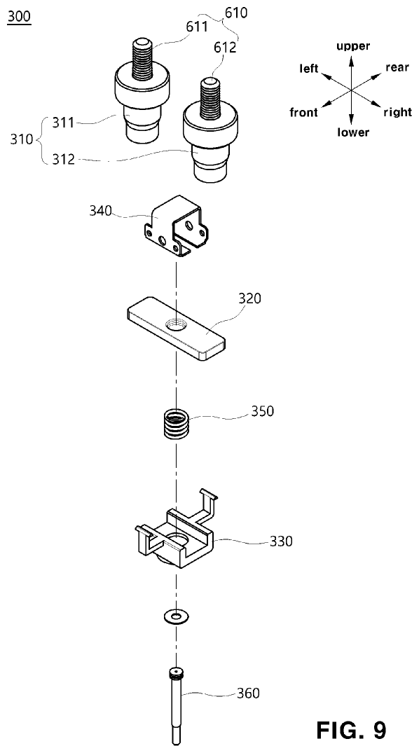

In the embodiment shown in FIG. 9, the main contact part 300 includes the fixed contactor 310, the movable contactor 320, a housing 330, a cover 340, a contact spring 350, and the shaft 360.

The fixed contactor 310 is in contact with or separated from the movable contactor 320 to apply or block internal and external electric current conduction of the DC relay 10.

Specifically, when the fixed contactor 310 is in contact with the movable contactor 320, the inside and outside the DC relay 10 may be conducting electric current. On the other hand, when the fixed contactor 310 is separated from the movable contactor 320, the electric current energization of the inside and outside the DC relay 10 may be blocked.

As can be seen from the name, the fixed contactor 310 is not moved. That is, the fixed contactor 310 is fixedly coupled to the upper frame 110 and the arc chamber 500. Thus, the contact and separation of the fixed contactor 310 and the movable contactor 320 are achieved by the movement of the movable contactor 320.

One end of the fixed contactor 310, that is, the upper end in the illustrated embodiment, is exposed to the outside the upper frame 110. The main terminal 610 of the terminal part 600 is electrically connected to one end.

A plurality of fixed contactors 310 may be provided. In the illustrated embodiment, two fixed contactors 310 are provided, including a first fixed contactor 311 on the left side and a second fixed contactor 312 on the right side.

The first fixed contactor 311 is positioned to be biased to one side, that is, the left in the illustrated embodiment, from the center in the longitudinal direction of the movable contactor 320. In addition, the second fixed contactor 312 is positioned to be biased to the other side, that is, the right in the illustrated embodiment, from the center in the longitudinal direction of the movable contactor 320.

A power source may be electrically connected to any one of the first fixed contactor 311 and the second fixed contactor 312. In addition, a load may be electrically connected to the other one of the first fixed contactor 311 and the second fixed contactor 312.

The other end of the fixed contactor 310, that is, the lower end in the illustrated embodiment, extends toward the movable contactor 320.

The movable contactor 320 comes into contact with the fixed contactor 310 according to the application of control power, so that the DC relay 10 is made energizing electric current with an external power supply and load. In addition, the movable contactor 320 is separated from the fixed contactor 310 when the application of control power is released, so that the DC relay 10 is made not energizing electric current with an external power supply and load.

The movable contactor 320 is positioned adjacent to the fixed contactor 310.

The upper side of the movable contactor 320 is partially covered by the cover 340. In an embodiment, a portion of the upper surface of the movable contactor 320 may be in contact with the lower surface of the cover 340.

The lower side of the movable contactor 320 is elastically supported by a contact spring 350. To prevent the movable contactor 320 from moving arbitrarily downward, the contact spring 350 may elastically support the movable contactor 320 in a compressed state by a predetermined distance.

The movable contactor 320 extends in the longitudinal direction, that is, left-right direction in the illustrated embodiment. That is, the length of the movable contactor 320 is longer than the width. Accordingly, opposite ends in the longitudinal direction of the movable contactor 320 accommodated in the housing 330 are exposed to the outside the housing 330. The fixed contactor 310 is in contact with both end.

The width of the movable contactor 320 may be the same as the distance at which each side surface of the housing 330 is spaced apart from each other. That is, when the movable contactor 320 is accommodated in the housing 330, opposite side surfaces of the movable contactor 320 in the width direction may contact inner surfaces of each side surface of the housing 330.

Accordingly, the state in which the movable contactor 320 is accommodated in the housing 330 can be stably maintained.

The housing 330 accommodates the movable contactor 320 and the contact spring 350 elastically supporting the movable contactor 320.

In the illustrated embodiment, one side of the housing 330 and the other side opposite thereto are open. A movable contactor 320 may be inserted through the open portion.

The non-open side surface of the housing 330 may be configured to surround the accommodated movable contactor 320.

The cover 340 is provided on the upper side of the housing 330. The cover 340 covers the upper surface of the movable contactor 320 accommodated in the housing 330.

The housing 330 and the cover 340 are preferably formed of an insulating material to prevent unintentional electric current energization. In an embodiment, the housing 330 and the cover 340 may be formed of a synthetic resin or the like.

The lower side of the housing 330 is connected to the shaft 360. When the movable core 220 connected to the shaft 360 is moved upward or downward, the housing 330 and the movable contactor 320 accommodated therein may also be moved upward or downward.

The housing 330 and the cover 340 may be coupled by any member. In an embodiment, the housing 330 and the cover 340 may be coupled by a fastening member (not shown) such as a bolt or nut.

The contact spring 350 elastically supports the movable contactor 320. When the movable contactor 320 comes into contact with the fixed contactor 310, the movable contactor 320 tends to be spaced apart from the fixed contactor 310 by electromagnetic repulsive force.

At this time, the contact spring 350 elastically supports the movable contactor 320 to prevent the movable contactor 320 from being arbitrarily separated from the fixed contactor 310.

The contact spring 350 may be provided in any form capable of storing a restoring force by deformation of a shape and providing the stored restoring force to other members. In an embodiment, the contact spring 350 may be provided as a coil spring.

One end of the coil spring 350 facing the movable contactor 320 is in contact with the lower side of the movable contactor 320. In addition, the other end of the contact spring 350 opposite to the one end is in contact with the upper side of the housing 330.

The contact spring 350 may elastically support the movable contactor 320 in a state in which a restoring force is stored after being compressed by a predetermined distance. Accordingly, even if an electromagnetic repulsive force is generated between the movable contactor 320 and the fixed contactor 310, the movable contactor 320 is not moved arbitrarily.

For stable coupling of the contact spring 350, a protrusion portion (not shown) inserted into the hollow of the contact spring 350 may protrude from the lower side of the movable contactor 320. Similarly, a protrusion portion (not shown) inserted into the hollow of the contact spring 350 may protrude from the upper side of the housing 330.

The shaft 360 transmits a driving force generated as the core part 200 is operated to the main contact part 300. Specifically, the shaft 360 is connected to the movable core 220 and the movable contactor 320. When the movable core 220 is moved upward or downward, the movable contactor 320 may be also moved upward or downward by the shaft 360.

The shaft 360 extends in the longitudinal direction, that is, vertical direction in the illustrated embodiment. The lower end of the shaft 360 is inserted into and coupled to the movable core 220. When the movable core 220 is moved in the vertical direction, the shaft 360 may be moved together with the movable core 220 in the vertical direction.

The body part of the shaft 360 is coupled to the stationary core 210 so as to be movable up and down. The core spring 260 is coupled through the body part of the shaft 360.

The upper end of the shaft 360 is coupled to the housing 330. When the movable core 220 is moved, the shaft 360 and the housing 330 may be moved together.

Upper and lower ends of the shaft 360 may be formed to have larger diameters than the body part of the shaft. Accordingly, the shaft 360 may be stably coupled to the housing 330 and the movable core 220.

The sub contact part 400 is electrically connected to the external control power (not shown), and receives control signals and currents applied to the core part 200. The sub contact part 400 may be electrically connected to the core part 200, and the applied control signal and current may be transmitted to the core part 200. Accordingly, the core part 200 may form a magnetic field to operate the main contact part 300.

The sub contact part 400 is accommodated in the upper space 111. In particular, the sub contact part 400 according to the embodiment of the present disclosure may be accommodated inside the arc chamber 500. Accordingly, the upper space 111 is sufficiently sized to accommodate the arc chamber 500, so that the overall size of the upper frame 110 and the DC relay 10 may be reduced.

In the above embodiment, the sub contact part 400 is formed so that the components included therein are not damaged by the arc generated inside the arc chamber 500. This will be described later in detail.

The sub contact part 400 is coupled to the first insulating plate 150. Specifically, each end of the sub contact part 400 facing the first insulating plate 150, that is, a lower end in the illustrated embodiment, is inserted into and supported by the holder support part 151.

In the illustrated embodiment, the sub contact part 400 includes a contact holder 401. The contact holder 401 may mount various components constituting the sub contact part 400. Various components of the sub contact part 400 may be physically spaced from the space inside the arc chamber 500 by the contact holder 401. Therefore, it can be said that the contact holder 401 functions as a type of housing.

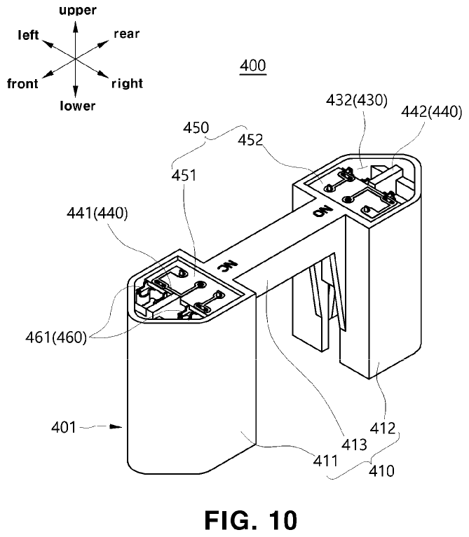

In the embodiment shown in FIGS. 10 to 13, the sub contact part 400 includes the body part 410, a switch accommodation part 420, a terminal accommodation part 430, a terminal partition member 440, a sub PCB 450, a sub connector 460, and a sub switch 470.

The body part 410 forms the outer shape of the sub contact part 400. The body part 410 is a portion where the sub contact part 400 is exposed to the inside of the arc chamber 500. Accordingly, it will be understood that the body part 410 may be referred to as the contact holder 401.

The body part 410 may be formed of a high heat resistance and high pressure resistance material. This is to prevent damage caused by heat or pressure generated with the arc inside the arc chamber 500.

In addition, the body part 410 may be formed of an insulating material. This is to prevent any electrical current between each component of the sub contact part 400 or other components of the sub contact part 400. In an embodiment, the body part 410 may be formed of a material such as ceramic or synthetic resin.

A space is formed inside the body part 410. Various components of the sub contact part 400 may be accommodated in the space. In the illustrated embodiment, the sub PCB 450, the sub connector 460, and the sub switch 470 are accommodated in the space formed in the body 410.

The body part 410 may be any shape that is supported by the first insulating plate 150 and located inside the arc chamber 500. In the illustrated embodiment, the body part 410 includes the first leg 411, the second leg 412, and a bridge 413.

The first leg 411 and the second leg 412 extend in the height direction of the DC relay 10, that is, in the up-down direction in the illustrated embodiment. The first leg 411 and the second leg 412 are configured to support the DC relay 10 in the up-down direction.

In the illustrated embodiment, the body part 410 includes a first leg 411 and a second leg 412, but the number of legs may be changed. The lower ends of the first leg 411 and the second leg 412 are coupled to the plurality of holder support parts 151, respectively (see FIG. 13).

Referring to FIG. 10, the radial outer sides of the first rack 411 and the second rack 412, that is, the front side of the first rack 411 and the rear side of the second rack 412, are formed with a plurality of planes continuous with each other. The remaining portions of the first rack 411 and the second rack 412 are composed of a single plane.

In other words, in the illustrated embodiment, the cross-sections of the first leg 411 and the second leg 412 are formed to have at least five sides. The shapes of the first leg 411 and the second leg 412 may be changed depending on the shape of the holder support part 151.

The upper ends of the first leg 411 and the second leg 412 are continuous with the bridge 413.

The bridge 413 extends between the first leg 411 and the second leg 412 to reinforce the rigidity of the first leg 411 and the second leg 412. In the illustrated embodiment, the bridge 413 extends in the front-rear direction, and each end is coupled to the first leg 411 and the second leg 412.

An indicator may be formed on one surface of the bridge 413, that is, the upper surface of the illustrated embodiment to recognize the state of the sub contact part 400 by the operator. In the illustrated embodiment, “NC”, i.e. Normal Close is displayed on the front side of the bridge 413, and “NO”, i.e. Normal Open is displayed on the rear side of the bridge 413.

The switch accommodation part 420, the terminal accommodation part 430, and the terminal partition member 440 are disposed inside the first leg 411 and the second leg 412.

The switch accommodation part 420 accommodates the sub switch 470. The switch accommodation part 420 is defined as a part of a space formed inside the first leg 411 and the second leg 412. One end of the switch accommodation part 420, that is, an upper side in the illustrated embodiment, are opened so that the sub switch 470 may be pulled in and out.

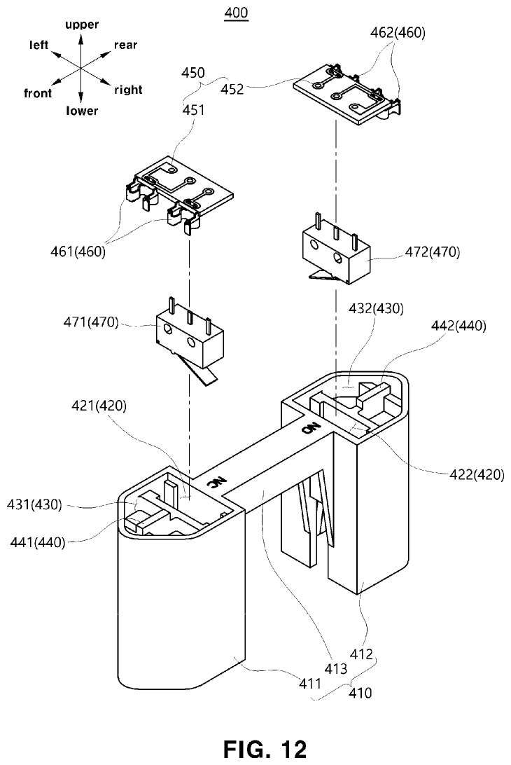

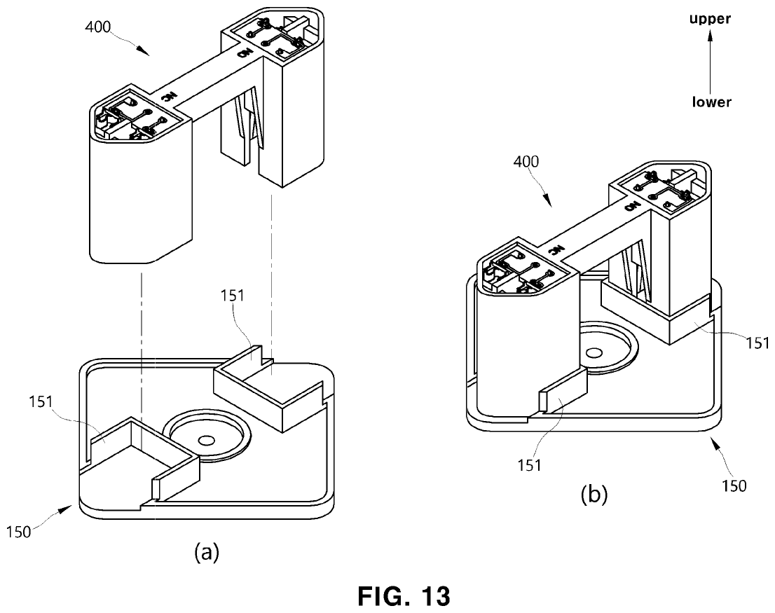

The switch accommodation part 420 may be formed to have a predetermined cross-sectional area and depth. As shown in FIG. 12, the cross-sectional area and depth of the switch accommodation part 420 are preferably determined depending on the shape of the sub switch 470.

A plurality of switch accommodation parts 420 may be formed. A plurality of switch accommodation parts 420 may be formed inside the first leg 411 and the second leg 412, respectively. In the embodiment shown in FIG. 12, two switch accommodating parts 420 are formed, including a first switch accommodation part 421 and a second switch accommodation part 422.

The first switch accommodation part 421 is located at the rear side of the first leg 411, and the second switch accommodation part 422 is located at the front side of the second leg 412. In other words, the switch accommodation part 420 may be represented as a space formed radially inside the inner space of the first leg 411 and the second leg 412.

The terminal accommodation part 430 is located adjacent to the switch accommodation part 420. The switch accommodating part 420 is partitioned with the terminal accommodating part 430 by a partition wall (not designated by reference numeral).

The terminal accommodation part 430 accommodates the sub connector 460. The terminal accommodation part 430 is defined as the other part of the space formed inside the first leg 411 and the second leg 412. One end of the terminal accommodation part 430, that is, the upper side in the illustrated embodiment, are form open so that the sub connector 460 may be pulled in and out.

The terminal accommodation part 430 may be formed to have a predetermined cross-sectional area and depth. As shown in FIG. 12, the cross-sectional area and depth of the terminal accommodation part 430 are preferably determined depending on the shape of the sub connector 460.

The terminal accommodation part 430 may be partitioned into a plurality of spaces. Sub connectors 460 may be accommodated in each of the plurality of partitioned spaces. In the illustrated embodiment, the terminal accommodation part 430 is partitioned into two spaces by the terminal partition member 440.

A plurality of terminal accommodation parts 430 may be formed. A plurality of terminal accommodation parts 430 may be formed inside the first leg 411 and the second leg 412, respectively. In the embodiment shown in FIG. 12, two terminal accommodation parts 430 are formed, including a first terminal accommodation part 431 and a second terminal accommodation part 432.

The first terminal accommodation part 431 is located at the front side of the first leg 411, and the second terminal accommodation part 432 is located at the rear side of the second leg 412. In other words, the terminal accommodation part 430 may be represented as a space formed radially outside the inner spaces of the first leg 411 and the second leg 412.

The terminal partition member 440 is located in the terminal accommodation part 430 to partition the terminal accommodation part 430 into a plurality of spaces. A plurality of sub connectors 460 may be accommodated in a plurality of partitioned spaces and may be physically and electrically spaced apart.

The terminal partition member 440 may be provided in any form capable of physically and electrically separating the terminal accommodation part 430. In the illustrated embodiment, the terminal partition member 440 is provided as a partition wall extending in the direction in which the bridge 413 extends, that is, in the front-rear direction.

A plurality of terminal partition members 440 may be provided. The plurality of terminal partition members 440 may partition the plurality of terminal accommodation parts 430 into plural. In the illustrated embodiment, two terminal partition member 440 are provided, including a first terminal partition member 441 located in the first terminal accommodation part 431 and a second terminal partition member 442 located in the second terminal accommodation part 432.

One end of the switch accommodation part 420 and the terminal accommodation part 430, that is, the upper end of the illustrated embodiment, communicate with each other. The sub PCB 450 may be accommodated in the space formed by the communication.

The sub PCB 450 is operated by a control signal and current applied through conductive wire member W. The sub PCB 450 controls the operation of the core part 200 by applying or releasing current to the coil 250 of the core part 200. Accordingly, the main contact part 300 may also be operated so that the DC relay 10 may be electrically connected to or blocked electrical conduction from the external power and the load.

The sub PCB 450 is electrically connected to the sub connector 460 and the sub switch 470, respectively. The sub PCB 450 may process the current, control signal transmitted through the sub connector 460 and control signal applied through the sub switch 470, and transmit it to other components.

The sub PCB 450 is accommodated in contact holder 401. Specifically, the sub PCB 450 is accommodated in a space formed on one side where the switch accommodation part 420 and the terminal accommodation part 430 communicate, that is, on the upper side in the illustrated embodiment.

To this end, the upper end of the partition wall member and the terminal partition member 440 partitioning the switch accommodation part 420 and the terminal accommodation part 430 may be positioned lower than the upper ends of the first leg 411 and the second leg 412.

In an embodiment, a portion of the sub PCB 450 may be accommodated in the switch accommodation part 420, and the other portion of the sub PCB 450 may be accommodated in the terminal accommodation part 430. In the above embodiment, the sub PCB 450 may be supported by a partition wall (not designated by reference numeral) and a terminal partition member 440 that partitions the switch accommodation part 420 and the terminal accommodation part 430.

A plurality of sub PCBs 450 may be provided. The plurality of sub PCBs 450 may be accommodated in the first leg 411 and the second leg 412, respectively. In the illustrated embodiment, two sub PCBs 450 are provided, including a first sub PCB 451 accommodated inside the first leg 411 and a second sub PCB 452 accommodated inside the second leg 412.

The first sub PCB 451 is accommodated in the first switch accommodation part 421 and the first terminal accommodation part 431 formed in the first leg 411. The second sub PCB 452 is accommodated in the second switch accommodation part 422 and the second terminal accommodation part 432 formed inside the second leg 412.

The sub connector 460 conducts the conductive wire member W and the sub PCB 450. The sub connector 460 may be coupled to the sub PCB 450 and may be removably coupled to the conductive wire member W.

The sub connector 460 is coupled to sub PCB 450. In the illustrated embodiment, the sub connector 460 is coupled to the outer edge of the sub PCB 450. The sub connector 460 is electrically connected to sub PCB 450.

The sub connector 460 is accommodated in the terminal accommodation part 430. In this case, a plurality of sub connectors 460 may be coupled to the single sub PCB 450 and may be accommodated in the terminal accommodation part 430, respectively. In the illustrated embodiment, two sub connectors 460, that is, a pair of sub connectors 460, are coupled to a single sub PCB 450.

The pair of sub connectors 460 may be physically and electrically spaced apart from each other. The pair of sub connectors 460 may each be accommodated in a plurality of spaces where the terminal accommodation part 430 is partitioned by the terminal partition member 440.

The sub connector 460 may be provided in a plurality of pairs. The plurality of pairs of sub connectors 460 may be coupled to and electrically connected to different sub PCBs 450. In the illustrated embodiment, two pairs of sub connectors 460 are provided, including a pair of first sub connectors 461 that are coupled to and electrically connected to the first sub PCB 451 and a pair of second sub connectors 462 that are coupled to and electrically connected to the second sub PCB 452.

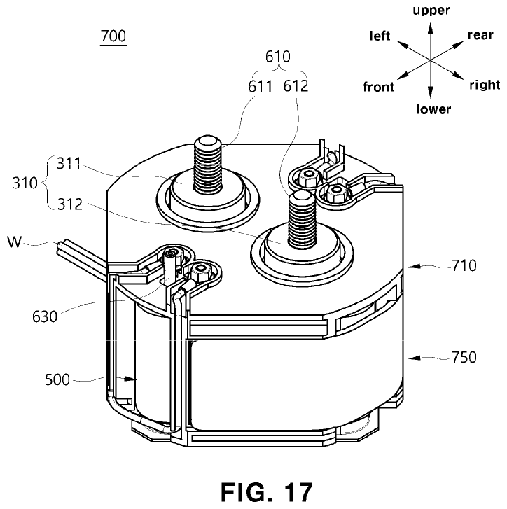

The sub connector 460 is electrically connected to conductive wire member W. As shown in FIG. 17, the conductive wire member W may be electrically connected to the sub terminal 620 of the terminal part 600, and the sub terminal 620 may be electrically connected to the sub connector 460, so that the sub connector 460 may be electrically connected to an external control power.

The sub connector 460 is electrically connected to sub switch 470 through sub PCB 450.

The sub switch 470 is electrically connected to the sub PCB 450, and applies a control signal to operate the sub PCB 450. The sub switch 470 may be configured to operate the state of the sub contact part 400 as “NO” or “NC”.

The sub switch 470 may be configured to be operated even at a minute pressure. In an embodiment, it may be configured to return to its original position when external pressure, including an elastic member such as a spring, disappears.

The sub switch 470 is located adjacent to sub PCB 450. The sub switch 470 is accommodated in the switch accommodation part 420 formed inside the body part 410. As described above, the switch accommodation part 420 is partitioned by the terminal accommodation part 430 and the partition wall, and the sub switch 470 and the sub connector 460 are physically spaced apart.

A plurality of sub switches 470 may be provided. The plurality of sub switches 470 may be coupled to and electrically connected to the plurality of sub PCBs 450, respectively. In the illustrated embodiment, the sub switch 470 includes a first sub switch 471 coupled to the first sub PCB 451 located on the front side and a second sub switch 472 coupled to the second sub PCB 452 located on the rear side.

The first sub switch 471 is accommodated in the first switch accommodation part 421 formed in the first leg 411. The second sub switch 472 is accommodated in the second switch accommodation part 422 formed in the second leg 412.

The arc chamber 500 extinguishes an arc generated when the fixed contactor 310 and the movable contactor 320 are spaced apart from each other in the inner space (hereinafter referred to as chamber space 501). Accordingly, the arc chamber 500 may be referred to as an “arc extinguishing part”.

The chamber space 501 of the arc chamber 500 accommodates the main contact part 300 and the sub contact part 400. Also, the arc inducing part 700 is coupled to the outside the arc chamber 500. Accordingly, the arc formed when the fixed contactor 310 and the movable contactor 320 of the main contact part 300 contact or are spaced apart may be induced and extinguished by the arc inducing part 700.

The movable contactor 320 is accommodated in the chamber space 501 of the arc chamber 500 so as to be capable of being raised and lowered. The movable contactor 320 may be lifted up and down in a direction toward and in a direction opposite to the fixed contactor 310 in the state of being accommodated in the chamber space 501.

The chamber space 501 may be filled with arc-extinguishing gas. The gas for extinguishing allows the generated arc to be extinguished and discharged to the outside the DC relay 1 through a preset path. To this end, a communication hole (not shown) may be formed through a wall surrounding the chamber space 501.

The arc chamber 500 may be formed of an insulating material. In addition, the arc chamber 500 may be formed of a material with pressure resistance and high heat resistance. This is due to the fact that the generated arc is a flow of high temperature and high pressure electrons. In an embodiment, the arc chamber 500 may be formed of a ceramic material.

In an embodiment, the arc chamber 500 may is accommodated inside the frame 100. Specifically, the arc chamber 500 is accommodated in the upper space 111 and the outer side thereof is surrounded by the upper frame 110. The arc inducing part 700 is disposed between the arc chamber 500 and the upper frame 110, so that the generated arc may be induced.

The arc chamber 500 may be any shape capable of accommodating the main contact part 300 and the sub contact part 400 in the chamber space 501 and extinguishing the generated arc. In the illustrated embodiment, the arc chamber 500 has a rectangular cross-section and is formed in a square pillar shape extending in the up-down direction.

In particular, the arc chamber 500 according to the embodiment of the present disclosure may secure a sufficient insulating distance between the main contact part 300 and the sub contact part 400 by its own structure without deforming the shape of the frame 100. Additionally, a space large enough for the generated arc to be extinguished may be secured inside the arc chamber 500.

Furthermore, the arc inducing part 700 provided at the outside thereof is also disposed in various forms by the structure of the arc chamber 500, so that the generated arc may be effectively induced. This will be described later in detail.

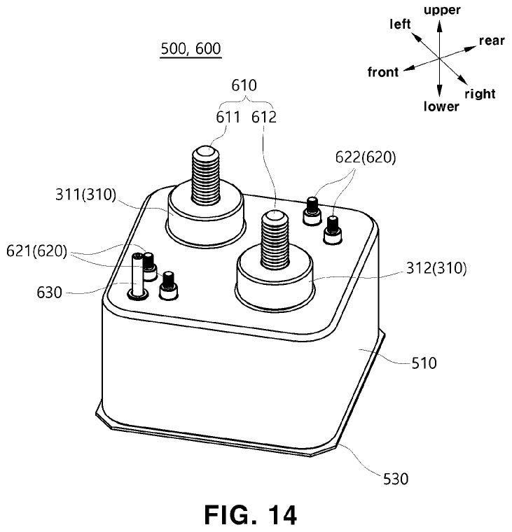

In the illustrated embodiment in FIGS. 14 to 18, the arc chamber 500 includes a wall body part 510, an opening part 520, and a sealing member 530.

The wall body part 510 forms the outer surface of the arc chamber 500. The wall body part 510 is disposed to surround the chamber space 501 in various directions. The wall body part 510 may be formed of a highly heat resistant and highly insulating material. In an embodiment, the wall body part 510 may be formed of a ceramic material.

A plurality of wall body parts 510 may be provided. The plurality of wall body parts 510 may be disposed to surround the chamber space 501 at different positions. The wall body parts 510 disposed adjacent to each other may be continuous at a predetermined angle.

In the illustrated embodiment, the wall body part 510 includes a first wall 511, a second wall 512, a third wall 513, a fourth wall 514, and a fifth wall 515.

The first wall 511 forms one surface of the arc chamber 500, that is, a left surface of the front in the illustrated embodiment. The second wall 512 forms the other surface of the arc chamber 500, that is, a right surface of the front in the illustrated embodiment. The third wall 513 forms another surface of the arc chamber 500, that is, a left surface of the rear in the illustrated embodiment. In addition, the fourth wall 514 forms another surface of the arc chamber 500, that is, a right surface of the rear in the illustrated embodiment.

Furthermore, the fifth wall 515 forms another surface of the arc chamber 500, that is, an upper surface of the illustrated embodiment.

In this case, the first wall 511 and the fourth wall 514 are disposed to face each other with the chamber space 501 interposed therebetween. In addition, the second wall 512 and the third wall 513 are disposed to face each other with the chamber space 501 interposed therebetween.

The first to fifth walls 511 to 515 may be continuous with adjacent walls forming a predetermined angle. In the illustrated embodiment, the first wall 511 is continuous with the second wall 512, third wall 513, and fifth wall 515. Additionally, the second wall 512 is continuous with the first wall 511, fourth wall 514, and fifth wall 515. In an embodiment, the predetermined angle may be orthogonal.

In an embodiment, the first wall 511 and the fourth wall 514 facing each other may extend parallel to each other. Additionally, the second wall 512 and third wall 513 facing each other may extend parallel to each other. At this time, the first wall 511 and the fourth wall 514 may extend by the same length. Additionally, the second wall 512 and the third wall 513 may also extend by the same length.

In the above embodiment, the shape of the horizontal cross-section of the arc chamber 500 may be a rectangular shape, especially a diamond shape. In the illustrated embodiment, the arc chamber 500 is formed such that the first wall 511, the second wall 512, the third wall 513, and the fourth wall 514 extend by the same length. Accordingly, in the above embodiment, the arc chamber 500 is formed to have a square cross-section in its horizontal direction.

Accordingly, the distance between at least one pair of vertices of the two pairs of vertices arranged to face each other with the chamber space 501 in between among the vertices of the cross-section of the arc chamber 500 may be longer than the distance between the walls facing each other.

Therefore, when the first fixed contactor 311 and the second fixed contactor 312 are disposed adjacent to a pair of vertices facing each other, and the first leg 411 and the second leg 412 of the sub contact part 400 are disposed adjacent to another pair of vertices facing each other, the insulating distance between the main contact part 300 and the sub contact part 400 may be sufficiently secured.

The first wall 511, the second wall 512, the third wall 513, and the fourth wall 514 may be surrounded by a magnet part 740 provided in the arc inducing part 700. Accordingly, the first wall 511, the second wall 512, the third wall 513, and the fourth wall 514 may diverge or converge a magnetic field that induces an arc by the magnet part 740 on the outside thereof.

The first wall 511, the second wall 512, the third wall 513, and the fourth wall 514 are each continuous with the fifth wall 515.

The fifth wall 515 is configured to cover the chamber space 501 from another side, that is, an upper side in the illustrated embodiment. The fifth wall 515 forms an upper surface of the wall body part 510.

The opening part 520 is formed in the fifth wall 515. The fixed contactor 310 and the terminal part 600 partially accommodated in the chamber space 501 may enter the chamber space 501 through the opening part 520.

In the illustrated embodiment, the wall body part 510 is formed to surround the chamber space 501 in five directions. Therefore, it will be understood that the lower side of the chamber space 501, that is, the direction toward the lower frame 120, is opened, but is closed by the support plate 140 and the first insulating plate 150.

The opening part 520 functions as a passage through which components partially accommodated in the chamber space 501 pass. The opening part 520 is formed through one wall of the wall body part 510, that is, a fifth wall 515 located on the upper side in the illustrated embodiment.

A plurality of opening parts 520 may be formed. The plurality of opening parts 520 may be spaced apart from each other, and different components may be respectively coupled through. In the illustrated embodiment, the opening parts 520 include a main opening part 521, a sub opening part 522, and a pipe opening part 523.

The fixed contactor 310 is coupled through the main opening part 521. A portion of the extension direction of the fixed contactor 310, that is, the lower side in the illustrated embodiment, may penetrate the main opening part 521 and located in the chamber space 501. The remaining portion of the extension direction of the fixed contactor 310, that is, the upper side in the illustrated embodiment, may be exposed to the outside the chamber space 501 to be coupled to and electrically connected to the main terminal 610.

A plurality of main opening parts 521 may be provided. A plurality of fixed contactors 310 may penetrate each of the plurality of main opening parts 521. In the illustrated embodiment, the main opening parts 521 include a first main opening part 521a located at the left side through which the first fixed contactor 311 passes, and a second main opening part 521b located at the right side through which the second fixed contactor 312 passes.

The sub opening part 522 is formed apart from the main opening part 521.

The sub terminal 620 of the terminal part 600 is coupled through the sub opening part 522. A portion of the extension direction of the sub terminal 620, that is, the lower side in the illustrated embodiment, may penetrate the sub opening part 522 and located in the chamber space 501. The remaining portion of the extension direction of the sub terminal 620, that is, the upper side in the illustrated embodiment, may be exposed to the outside the chamber space 501 to be coupled to and electrically connected to the conductive wire member W.

The sub opening parts 522 may be formed in a plurality of groups or pairs. A plurality of sub terminals 620 may penetrate each of the plurality of groups of sub opening parts 522. In the illustrated embodiment, the sub opening parts 522 include a first sub opening part 522a that is biased toward the front side through which the first sub terminal 621 passes, and a second sub opening part 522b that is biased toward the rear side through which the second sub terminal 622 passes.

A plurality of first sub opening parts 522a and a plurality of second sub opening parts 522b may each be formed. A plurality of first sub terminals 621 and 622 may penetrate the plurality of first sub opening parts 522a and the plurality of second sub opening parts 522b, respectively. In the illustrated embodiment, two first sub opening part 522a and a second sub opening part 522b are each provided, and two first sub terminal 621 and a second sub terminal 622 pass through them, respectively.

The number and arrangement of the first sub opening part 522a and the second sub opening part 522b may vary depending on the number and arrangement of the sub connector 460 and the sub terminal 620.

A pipe member 630 of the terminal part 600 is coupled through the pipe opening part 523. A portion of the extension direction of the pipe member 630, that is, the lower side in the illustrated embodiment, may penetrate the pipe opening part 523 and located in the chamber space 501. The remaining portion of the extension of the pipe member 630, that is, the upper side in the illustrated embodiment, may be exposed to the outside the chamber space 501 to serve as a path through which the extinguished arc is discharged.

The pipe opening part 523 is located adjacent to the sub opening part 522. In the illustrated embodiment, the pipe opening part 523 is located adjacent to the first sub opening part 522a, located on the front side. The position of the pipe opening part 523 may be changed to any position in which the chamber space 501 communicates with the outside to cause the arc to be extinguished and discharged.

The sealing member 530 forms one side of the arc chamber 500 facing the lower frame 120, that is, the lower end in the illustrated embodiment. The sealing member 530 may extend along the edge of the one end of the arc chamber 500, that is, the lower end.

The sealing member 530 ensures the airtightness between the arc chamber 500 and the support plate 140. Therefore, the arc chamber 500 and the support plate 140 are hermetically coupled so that the arcs and the like are not anyway leaked therebetween.

A hollow is formed inside the sealing member 530. Therefore, the lifting and lowering of the shaft 360 and the movable contactor 320 coupled thereto is not degraded by the sealing coupling of the arc chamber 500 and the support plate 140.

The terminal part 600 communicates the main contact part 300 and the sub contact part 400 with the external power source or external load. The terminal part 600 is coupled through the arc chamber 500, and a portion of the terminal part 600 is located inside the arc chamber 500 (i.e., the chamber space 501) and the other portion is located outside the arc chamber 500.

The terminal part 600 is coupled through the opening part 520 of the arc chamber 500. The terminal part 600 may be supported by the fifth wall 515.

The terminal part 600 may be formed of any material that can be electrically connected to other coupled members. In an embodiment, the terminal part 600 may be formed of a copper (Cu) material.

In the illustrated embodiment, each component of the terminal part 600 has a circular cross-section and has a cylindrical shape extending in the up-down direction, but the shape thereof may be changed depending on the shape of the fixing contactor 310 and the opening part 520 of the arc chamber 500.

In the illustrated embodiment in FIGS. 14 to 18, the terminal part 600 includes the main terminal 610, the sub terminal 620, and the pipe member 630.

The main terminal 610 connects the fixed contactor 310 to the external power source and the external load. The main terminal 610 is coupled to and electrically connected to the fixed contactor 310, the external power source and the external load, respectively.

A plurality of main terminals 610 may be provided. The plurality of main terminals 610 may be coupled to and electrically connected to each of the plurality of fixed contactors 310. In the illustrated embodiment, the main terminal 610 includes a first main terminal 611 located at the left side, coupled to and electrically connected to the first fixed contactor 311 and a second main terminal 612 located at the right side, coupled to and coupled to and electrically connected to the second fixed contactor 312.

The sub terminal 620 connects the sub connector 460 of the sub contact part 400 to the external control power source (not shown). The sub terminal 620 is coupled to and electrically connected to the sub connector 460 and the conductive wire member W, respectively. It will be understood that the conductive wire member W is coupled to and electrically connected to the external control power source (not shown).

A plurality of sub terminals 620 may be provided. The plurality of sub terminals 620 may be coupled to and electrically connected to the plurality of sub connectors 460. In the illustrated embodiment, the sub terminal 620 includes a pair of first sub terminals 621 that are located at the front side, coupled to and electrically connected to a pair of first sub connectors 461, respectively, and a pair of second sub terminals 622 that are located at the rear side, coupled to and electrically connected to a pair of second sub connectors 462, respectively.

The first sub terminal 621 is coupled through the first sub opening part 522a, and the second sub terminal 622 is coupled through the second sub opening part 522b.

The pipe member 630 forms a path through which the arc generated in the chamber space 501 is extinguished and discharged to the outside. The pipe member 630 is extended in the direction in which the main terminal 610 or the sub terminal 620 extends, that is, in the vertical direction in the illustrated embodiment. A hollow formed through the pipe member 630 along its extension direction may be formed inside the pipe member 630, and a path through which the arc is discharged may be formed.

The pipe member 630 is coupled through the pipe opening part 523. One end of the pipe member 630 may be located in the chamber space 501, and the other end may be located outside the chamber space 501.

The arc inducing part 700 forms a magnetic field for inducing an arc generated inside the arc chamber 500, that is, in the chamber space 501. As is known, the formed magnetic field forms a magnetic force together with the current supplied to the fixed contactor 310 and the movable contact 320. The generated arc extends along the direction of the formed magnetic force and may be extinguished and discharged.

The arc inducing part 700 is located outside the arc chamber 500. The arc inducing part 700 surrounds the arc chamber 500 and is coupled to the arc chamber 500. In the illustrated embodiment in FIG. 17, the arc inducing part 700 is coupled to surround each surface of the arc chamber 500 in the upper and outer circumferential directions.

The arc inducing part 700 may be removably coupled to the arc chamber 500. In the above example, only components requiring maintenance or replacement of the arc chamber 500 or the arc guiding unit 700 may be separated.

The arc inducing part 700 is accommodated inside the frame 100. Specifically, the arc inducing part 700 is accommodated in the upper space 111 of the upper frame 110. At this time, the arc inducing part 700 is located between the arc chamber 500 and the upper frame 110. That is, along the radially inner direction, the outer circumferential surface of the upper frame 110, the arc inducing part 700, and the arc chamber 500 are sequentially arranged.

The arc inducing part 700 may be coupled to the conductive wire member W. The conductive wire member W may extend along the arc inducing part 700, in a state where a portion of the conductive wire member W is coupled to the arc inducing part 700, the end portion of the conducting wire member W may be coupled to and electrically connected to the sub terminals 620.

Each component of the arc inducing part 700 to be described below may be removably coupled to each other. Therefore, when maintenance of specific components of the arc induction unit 700 is required, only the components may be replaced and used, thereby improving economic efficiency and productivity.

In the illustrated embodiment in FIGS. 17 to 20, the arc inducing part 700 includes a magnet housing 710, an arc opening part 720, a second insulating plate 730, a magnet part 740, and a magnet cover member 750.

The magnet housing 710 forms the outer shape of the arc inducing part 700. The magnet housing 710 may be coupled to other components of the arc inducing part 700.

The magnet housing 710 is formed to surround the arc chamber 500. The magnet housing 710 is formed to surround at least one of the walls of the arc chamber 500 surrounding the chamber space 501. In the illustrated embodiment, the magnet housing 710 is formed to surround the first to fourth walls 511, 512, 513, 514 positioned radially outside the chamber space 501 in the horizontal direction and the fifth wall 515 positioned to cover the chamber space 501 on the upper side.

A magnet part 740 is accommodated in the magnet housing 710. The magnet part 740 may form a magnetic field in the chamber space 501 in a state of being accommodated in the magnet housing 710.

The magnet housing 710 may be formed of an insulating material. It is to prevent the magnet part 740 accommodated in the magnet housing 710 from being randomly electrically connected to each other or the magnetic field formed by any one of the magnet part 740 from being affected by other magnets. In an embodiment, the magnet housing 710 may be formed of a ceramic material similar to the arc chamber 500.

In the illustrated embodiment, the magnet housing 710 includes a first support wall 711, a second support wall 712, a third support wall 713, a fourth support wall 714, and a cover member 715.

The first support wall 711 forms one surface of the magnet housing 710, that is, a left surface of the front in the illustrated embodiment. The first support wall 711 is formed to surround the first wall 511 of the arc chamber 500 from the outside.

Inside the first support wall 711, a space that is penetrated in its thickness direction, that is, in the direction toward the left side of the front and the right side of the rear in the illustrated embodiment, is formed. The space may be defined as a first magnet space part 711a. The first magnet 741 may be removably coupled to the first magnet space part 711a. The first magnet space part 711a may be formed to correspond to the shape of the first magnet 741.

The second support wall 712 forms the other surface of the magnet housing 710, that is, the right surface of the front in the illustrated embodiment. The second support wall 712 is formed to surround the second wall 512 of the arc chamber 500 from the outside.

Inside the second support wall 712, a space that is penetrated in the thickness direction, that is, in the direction toward the right side of the front and the left side of the rear in the illustrated embodiment, is formed. The space may be defined as a second magnet space part 712a. The second magnet 742 may be removably coupled to the second magnet space part 712a. The second magnet space part 712a may be formed to correspond to the shape of the second magnet 742.

The third support wall 713 forms another surface of the magnet housing 710, that is, the left surface of the rear in the illustrated embodiment. The third support wall 713 is formed to surround the third wall 513 of the arc chamber 500 from the outside.

Inside the third support wall 713, a space that is penetrated in the thickness direction, that is, in the direction toward the right side of the front and the left side of the rear in the illustrated embodiment, is formed. The space may be defined as a third magnet space part 713a. The third magnet 743 may be removably coupled to the third magnet space part 713a. The third magnet space part 713a may be formed to correspond to the shape of the third magnet 743.

The fourth support wall 714 forms another surface of the magnet housing 710, that is, the right surface of the rear in the illustrated embodiment. The fourth support wall 714 is formed to surround the fourth wall 514 of the arc chamber 500 from the outside.

Inside the fourth support wall 714, a space that is penetrated in the thickness direction, that is, in the direction toward the left side of the front and the right side of the rear in the illustrated embodiment, is formed. The space may be defined as a fourth magnet space part 714a. The fourth magnet 744 may be removably coupled to the fourth magnet space part 714a. The fourth magnet space part 714a may be formed to correspond to the shape of the fourth magnet 744.

At this time, the first support wall 711 and the third support wall 713 facing each other may extend parallel to each other by the same length. Additionally, the second support wall 712 and the fourth support wall 714 facing each other may also extend parallel to each other by the same length.

In the illustrated embodiment, the coupling parts of the walls 511, 512, 513, and 514 located adjacent to each other among the first to fourth walls 511, 512, 513, and 514 are formed to be rounded and convex outwardly. On the other hand, the first to fourth support walls 711, 712, 713, and 714 are formed to be flat, so it is not easy to surround the coupling parts.

Accordingly, the first to fourth support walls 711, 712, 713, and 714 may extend by a predetermined length in the horizontal direction. In this case, the horizontal extension length of the first to fourth support walls 711, 712, 713, and 714 may be shorter than the horizontal extension length of the first to fourth walls 511, 512, 513, and 514.

Therefore, a predetermined space is formed between each of the first to fourth support walls 711, 712, 713, and 714 that are located adjacent to each other. Through the predetermined space, coupling parts of the walls 511, 512, 513, and 514 located adjacent to each other among the first to fourth walls 511, 512, 513, and 514 may be exposed. The parts may be surrounded by the magnet cover member 750, which will be described later.

The first to fourth support walls 711, 712, 713, and 174 are coupled to the cover member 715. The first to fourth support walls 711, 712, 713, and 714 form a predetermined angle with the cover member 715 and extend in a direction toward the lower frame 120, that is, downward in the illustrated embodiment.

In an embodiment, the predetermined angle may be the same as the angle between the first to fourth walls 511, 512, 513, and 514 and the fifth wall 515 of the arc chamber 500. In an embodiment, the predetermined angle may be orthogonal.

The cover member 715 forms another surface of the magnet housing 710, that is, the upper surface in the illustrated embodiment. The cover member 715 is formed to surround the fifth wall 515 of the arc chamber 500 from the outside.

The second insulating plate 730 is provided between the cover member 715 and the fifth wall 515, so that any electrical conduction between the cover member 715 and the fifth wall 515 to the arc chamber 500 may be blocked.

Inside the cover member 715, a plurality of opening parts are formed in a thickness direction thereof, that is, in the up-down direction in the illustrated embodiment. A plurality of fixed contactors 310 may be coupled through the opening part.

The cover member 715 may be formed in a shape corresponding to the shape of the fifth wall 515. Accordingly, the cover member 715 may be formed to completely cover the fifth wall 515 from the upper side. Therefore, the lower portion of the magnet housing 710 is formed open.

In the illustrated embodiment, the cover member 715 includes four edges, and each pair of edges facing each other extends parallel to each other, and the continuous portions of adjacent edges are rounded and chamfered. In an embodiment, the cover member 715 may have a diamond or square cross-section. It will be understood that the shape is the same as the shape of the horizontal cross-section of the arc chamber 500.

The space formed surrounded by the first to fourth support walls 711, 712, 713, and 714 and the cover member 715 may be defined as an accommodation space S. The arc chamber 500 is retractably accommodated in the accommodation space S. The lower side of the accommodation space S is opened, so that the arc chamber 500 may be pulled in and out the accommodation space S through the lower side.

An opening part communicating with the outside may be formed in a portion of the radially outside the accommodation space S. It will be understood that the opening part is a space formed by spacing apart from adjacent support walls among the first to fourth support walls 711, 712, 713, and 714.

In the illustrated embodiment, the cover member 715 includes a plurality of edges, which are continuous with the first to fourth support walls 711, 712, 713, and 714, wherein continuous portions of the plurality of the edges are rounded and chamfered. The portions may be covered by the magnet cover member 750, which will be described later.

The fixed contactor 310 is coupled through the arc opening part 720. The fixed contactor 310 may sequentially penetrate the arc opening part 720, the plurality of opening parts formed through the second insulating plate 730, and the main opening part 521 to extend between the chamber space 501 and the outside the upper frame 110.

The arc opening part 720 is formed through the inside of the cover member 715. The arc opening part 720 is formed through the thickness direction of the cover member 715, that is, in the up-down direction in the illustrated embodiment, and communicates the lower and upper sides of the cover member 715.

The arc opening part 720 communicates with a plurality of opening parts formed through the second insulating plate 730. In addition, the arc opening part 720 communicates with the main opening part 521 formed in the arc chamber 500. Accordingly, the arc opening part 720 may communicate with the chamber space 501.

A plurality of arc opening parts 720 may be formed. A plurality of fixed contactors 310 may be coupled through each of the plurality of arc opening parts 720. In addition, the conductive wire member W may penetrate or be accommodated in another portion of the plurality of arc opening parts 720.

In the illustrated embodiment, the arc opening parts 720 include a first arc opening part 721 formed on the left side through which the first fixed contactor 311 passes, and a second arc opening part 722 formed on the right side through which the second fixed contactor 312 passes. The shape of the first arc opening part 721 and the second arc opening part 722 may be changed depending on the shape of the fixed contactor 310.

In addition, in the illustrated embodiment, the arc opening part 720 includes a conductive wire accommodation part 723 that accommodates the end of the conductive wire member W and a conductive groove 724 that accommodates a portion of the remaining portion of the conductive wire member W.

The conductive wire accommodation part 723 is a portion where the end of the conductive wire member W is coupled to the sub terminal 620. The conductive wire accommodation part 723 includes one surface of the cover member 715, that is, a portion recessed by a predetermined depth on the upper surface, and another portion located inside the portion and formed through the cover member 715 in the thickness direction in the illustrated embodiment.

The sub terminal 620 may penetrate the cover member 715 through the other portion. The end of the conductive wire member W may be accommodated in above one portion, but may be coupled to and electrically connected to the end of the sub terminal 620.

In this case, the extended portion of the conductive wire member W, that is, the portion other than the end, is inserted into and coupled to the conductive wire groove 724 recessed in at least one of the first to fourth support walls 711, 712, 713, and 714.

A plurality of conductive wire accommodation parts 723 and conductive wire grooves 724 may be formed. As described above, in the illustrated embodiment, the sub terminals 620 include a pair of first sub terminals 621 and a pair of second sub terminals 622, and the conductive wire accommodation parts 723 may be formed on both the front side and the rear side to accommodate the first sub terminals 621 and the second sub terminals 622, respectively.

The conductive wire groove 724 may also be recessed in at least one of the first to fourth support walls 711, 712, 713, and 714. In the illustrated embodiment, the conductive wire grooves 724 are formed on the front and lower sides of the first and second support walls 711 and 712, and on the rear and lower sides of the third and fourth support walls 713 and 714, respectively.

The second insulating plate 730 prevents any electrical conduction between the cover member 715 and the arc chamber 500. The second insulating plate 730 is located between the cover member 715 and the fifth wall 515.

The second insulating plate 730 may be formed of an insulating material. In an embodiment, the second insulating plate 730 may be formed of a rubber or ceramic material.

The second insulating plate 730 may be formed to correspond to the shape of the fifth wall 515 and the cover member 715. In the illustrated embodiment, the second insulating plate 730 has a diamond or square shape in which each pair of edges facing each other extends parallel, like the fifth wall 515 or the cover member 715.

A plurality of through holes are formed inside the second insulating plate 730.

A portion of the plurality of through holes, that is, a pair of through holes spaced apart in the left and right directions and having a relatively large cross-section in the illustrated embodiment, communicate with the arc opening part 720 and the main opening part 521. The fixed contactors 310 are respectively coupled through the pair of through holes.

Another portion of the plurality of through holes, that is, two pairs of through holes spaced apart in the left and right directions and having a relatively small cross-section in the illustrated embodiment, communicate with the arc opening part 720 and the sub opening part 522. The sub terminals 620 are respectively coupled through the two pairs of through holes.

The remaining portion of the plurality of through holes, that is, a single through hole located on the front side in the illustrated embodiment, communicate with the conductive wire accommodation part 723 and the pipe opening part 523 located on the front side. The pipe member 630 is coupled through the singular through hole

The magnet part 740 forms a magnetic field that generates a magnetic force for inducing an arc generated in the chamber space 501. An arc path A.P may be formed in the chamber space 501 by the magnetic field formed by the magnet part 740.

The magnet part 740 may be provided in any form that may be magnetized to form a magnetic field. In an embodiment, the magnet part 740 may be provided with a permanent magnet or an electromagnet.

The magnet part 740 is coupled to the magnet housing 710. Specifically, the magnet part 740 is retractably accommodated in the magnet space parts 711a, 712a, 713a, 714a of the magnet housing 710. Therefore, if maintenance or replacement of the magnet part 740 is required, the operator may separate and replace only the magnet part 740.

As described above, the magnet space parts 711a, 712a, 713a, 714a are formed to penetrate the support walls 711, 712, 713, and 714 in the thickness direction. Accordingly, the magnet part 740 may be disposed adjacent to the first to fourth walls 511, 512, 513, and 514 of the arc chamber 500.

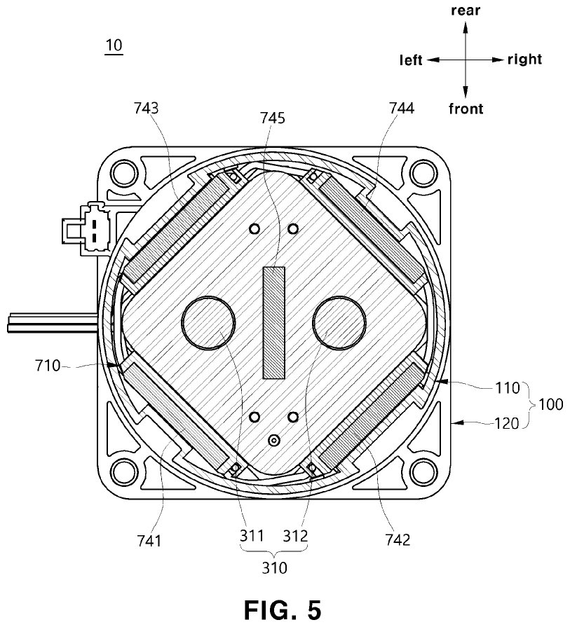

A plurality of magnet parts 740 may be provided. The plurality of magnet parts 740 may be respectively accommodated in the different magnet space parts 711a, 712a, 713a, and 714a to form a magnetic field. In the illustrated embodiment in FIG. 5, there are five magnet parts 740, including a first magnet 741, a second magnet 742, a third magnet 743, a fourth magnet 744, and a fifth magnet 745.

In the illustrated embodiment, the first to fifth magnets 741, 742, 743, 744, and 745 have a rectangular cross-section in which the length in one direction is longer than the length in the other direction, and are provided in a square plate shape extending in the vertical direction. The first to fifth magnets 741, 742, 743, 744, and 745 may be any shape capable of forming a magnetic field in the chamber space 501.

The first magnet 741 is accommodated in the first magnet space 711a to form a magnetic field in the chamber space 501. The first magnet 741 includes a first magnet outer surface 741a, which is one side opposite the chamber space 501, and a first magnet inner surface 741b, which is the other side facing the chamber space 501. The first magnet outer surface 741a and the first magnet inner surface 741b may be magnetized with different polarities.

The second magnet 742 is accommodated in the second magnet space 712a to form a magnetic field in the chamber space 501. The second magnet 742 includes a second magnet outer surface 742a, which is one side opposite the chamber space 501, and a second magnet inner surface 742b, which is the other side facing the chamber space 501. The second magnet outer surface 742a and the second magnet inner surface 742b may be magnetized with different polarities.

The third magnet 743 is accommodated in the third magnet space 713a to form a magnetic field in the chamber space 501. The third magnet 743 includes a third magnet outer surface 743a, which is one side opposite the chamber space 501, and a third magnet inner surface 743b, which is the other side facing the chamber space 501. The third magnet outer surface 743a and the third magnet inner surface 743b may be magnetized with different polarities.

The fourth magnet 744 is accommodated in the fourth magnet space 714a to form a magnetic field in the chamber space 501. The fourth magnet 744 includes a fourth magnet outer surface 744a, which is one side opposite the chamber space 501, and a fourth magnet inner surface 744b, which is the other side facing the chamber space 501. The fourth magnet outer surface 744a and the fourth magnet inner surface 744b may be magnetized with different polarities.

The fifth magnet 745 is located between the fifth wall 515 and the cover member 715 to form a magnetic field in the chamber space 501. The fifth magnet 745 is located between the first fixed contactor 311 and the second fixed contactor 312. The fifth magnet 745 includes a fifth magnet outer surface 745a, which is one side facing the first fixed contactor 311, and a fifth magnet inner surface 745b, which is the other side facing the second fixed contactor 312. The fifth magnet outer surface 745a and the fifth magnet inner surface 745b may be magnetized with different polarities.

The first to fifth magnets 741, 742, 743, 744, and 745 may independently or together form a magnetic field. A detailed description of the magnetic field formed by the magnet part 740 and the direction of the magnetic force according thereto will be described later.

The magnet cover member 750 couples the first to fourth support walls 711, 712, 713, and 714 of the magnet housing 710 to the first to fourth walls 511, 512, 513, and 514 of the arc chamber 500. The magnet cover member 750 stably maintains the coupling state between the magnet housing 710 and the magnet part 740 coupled thereto and the arc chamber 500.

The magnet cover member 750 forms a radially outer portion of the arc inducing part 700. The magnet cover member 750 covers other components of the arc inducing part 700 from the outside and may be coupled to the magnet housing 710.

In the illustrated embodiment, the magnet cover member 750 covers two magnets 741, 742, 743, and 744 disposed adjacent to each other and two support walls 711, 712, 713, and 714 disposed adjacent to each other to which they are coupled, and is coupled to the magnet housing 710.

At the same time, the magnet cover member 750 covers the space formed between the two support walls 711, 712, 713, and 714 (i.e., the space formed by the two support walls 711, 712, 713, and 714 being spaced apart from each other) and is coupled to the magnet housing 710.

A plurality of magnet cover members 750 may be provided. The plurality of magnet cover members 750 include a first magnet cover member 750a located on the left side and a second magnet cover member 750b located on the right side.

The first magnet cover member 750a is coupled to cover one portion of the outer side of the magnet housing 710 on one side of the magnet housing 710, that is, on the left side in the illustrated embodiment. As described above, it may be said that the first magnet 741 and the third magnet 743 are located relatively to the left side, and the first magnet cover member 750a covers the first magnet 741 and the third magnet 743 located on the left side and is coupled to the magnet housing 710.

The second magnet member 750b is coupled to cover the other portion of the outer side of the magnet housing 710 on the other side of the magnet housing 710, that is, on the right side in the illustrated embodiment. As described above, it may be said that the second magnet 742 and the fourth magnet 744 are located relatively to the right side, and the second magnet cover member 750b covers the second magnet 742 and the fourth magnet 744 located to the right side and is coupled to the magnet housing 710.

The magnet cover member 750 may be formed of an insulating material. In the above embodiment, the magnet part 740 surrounded by the magnet cover member 750 may form a magnetic field in the chamber space 501 without being affected by external magnetic materials or current.

In the illustrated embodiment, the magnet cover member 750 includes a first extension part 751, a second extension part 752, and a third extension part 753.

The first extension part 751 forms a portion of the magnet cover member 750. The first extension part 751 may have a predetermined thickness and may be provided in a plate shape extending in one direction. In the illustrated embodiment in FIGS. 17 to 20, the first extension part 751 is formed in a rectangular plate shape.

The first extension part 751 may cover at least one magnet of the magnet part 740 and may be coupled to the magnet housing 710. In the illustrated embodiment, the first extension part 751 of the first magnet cover member 750a covers the first magnet 741 and is coupled to the magnet housing 710. In addition, the first extension part 751 of the second magnet cover member 750b covers the second magnet 742 and is coupled to the magnet housing 710.

The first extension part 751 is continuous with the second extension part 752 through the third extension part 753.

The second extension part 752 forms another portion of the magnet cover member 750. The second extension part 752 may have a predetermined thickness and may be provided in a plate shape extending in one direction. In the illustrated embodiment in FIGS. 17 to 20, the second extension part 752 is formed in a rectangular plate shape.

In an embodiment, the first extension part 751 and the second extension part 752 may be formed to have the same shape.

The second extension part 752 covers at least one magnet of the magnet parts 740 and may be coupled to the magnet housing 710. In the illustrated embodiment, the second extension part 752 of the first magnet cover member 750a covers the third magnet 743 and is coupled to the magnet housing 710. In addition, the second extension part 752 of the second magnet cover member 750b covers the fourth magnet 744 and is coupled to the magnet housing 710.

A third extension part 753 is provided between the first extension part 751 and the second extension part 752.

The third extension part 753 is coupled to the first extension part 751 and the second extension part 752, respectively. The first extension part 751 and the second extension part 752 may be continuous via the third extension part 753.

The third extension part 753 may be coupled to each end of the first extension part 751 and the second extension part 752. In the illustrated embodiment, the front end of the third extension 753 is continuous with the rear end of the first extension 751, and the rear end is continuous with the front end of the second extension 752.

The third extension part 753 may include at least one curved portion. In the illustrated embodiment, the third extension 753 includes a curved portion that is rounded to be convex radially outward. The center of the curved portion may be located inside the magnet housing 710. In addition, the curvature of the curved portion may be the same as the curvature of the corners where the walls 511, 512, 513, and 514 adjacent to each other are continuous.

Therefore, when the magnet cover member 750 is coupled to the magnet housing 710, the first extension part 751 and the second extension part 752 surround different magnets 741, 742, 743, and 744, respectively, and the third extension part 753 surrounds the space formed between them.

Accordingly, the coupling state of each component of the arc inducing part 700 may be stably maintained.

The DC relay 10 according to the embodiment of the present disclosure described above may ensure a sufficient insulating distance between the main contact part 300 and the sub contact part 400 by structural features of the arc chamber 500 and the arc inducing part 700. Accordingly, even if the operation of the DC relay 10 is performed, electrical interference between the main contact part 300 and the sub contact part 400 may be reduced. In addition, damage to the sub contact part 400 due to the arc generated in the main contact part 300 may be minimized.

In addition, the DC relay 10 according to the embodiment of the present disclosure is accommodated inside the arc chamber 500 while various components of the sub contact part 400 are accommodated in a separate contact holder 401. The portion where various components of the sub contact part 400 are exposed to the chamber space 501 may be minimized.

Therefore, damage to the components of the sub contact part 400 due to the generated arc may be minimized. Accordingly, the durability margin of the DC relay 10 may be increased.

Furthermore, the arc inducing part 700 for forming the magnetic field in the chamber space 501 is disposed outside the arc chamber 500. Therefore, the space occupied by the member for forming the magnetic field in the chamber space 501 may be additionally secured. As a result, the space where the arc generated in the chamber space 501 may be extinguished and extended is also be increased, and the extinguishing performance of the arc may be improved.

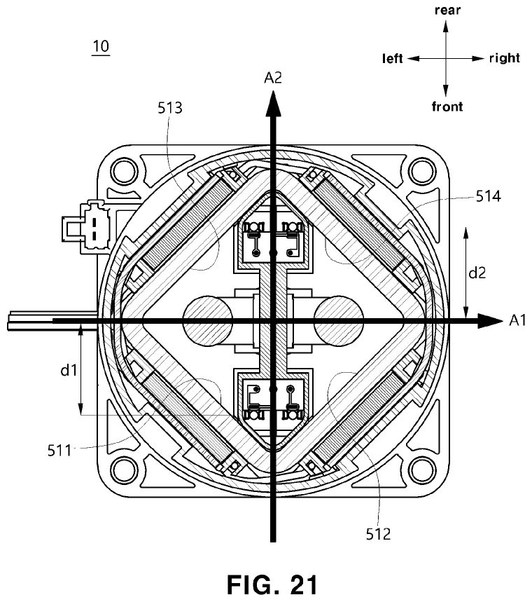

Hereinafter, the effects of the DC relay 10 according to the embodiment of the present disclosure will be described in detail with reference to FIGS. 21 to 25.

Referring to FIG. 21, an insulating distance between the main contact part 300 and the sub contact part 400 provided in the DC relay 10 according to the embodiment of the present disclosure is illustrated.

The main contact part 300 is located to be biased to each of a pair of vertices of the arc chamber 500, which is formed in a rectangular cross-section. In this case, the pair of vertices are disposed to face each other with the chamber space 501 interposed therebetween. That is, the main contact part 300 is disposed between the pair of vertices located farthest among the respective vertices of the arc chamber 500.

In the illustrated embodiment, the first fixed contactor 311 is disposed to be biased to the adjacent vertices of the first wall 511 and the third wall 513, which are located on the left side. In addition, the second fixed contactor 312 is disposed to be biased to the adjacent vertices of the second wall 512 and the fourth wall 514, which are located on the right side. In other words, the first fixed contactor 311 and the second fixed contactor 312 are disposed to be spaced apart from each other in the left-right direction.

In the above embodiment, the first fixed contactor 311 and the second fixed contactor 312 may be disposed on the central axis A1 extending in the left-right direction of the chamber space 501.

The sub contact part 400 is disposed to extend between the other pair of vertices of the arc chamber 500, which is formed in a rectangular cross-section. In this case, the other pair of vertices are also disposed to face each other with the chamber space 501 interposed therebetween. That is, the sub contact part 400 is disposed adjacent to the other pair of vertices located farthest among the respective vertices of the arc chamber 500.

In the illustrated embodiment, any one of the first leg 411 and the second leg 412 is disposed adjacent to the adjacent vertices of the first wall 511 and the second wall 512, which are located on the front side. In addition, the other one of the first leg 411 and the second leg 412 is disposed adjacent to the adjacent vertices of the third wall 513 and the fourth wall 514, which are located on the rear side.

In the above embodiment, the first leg 411 and the second leg 412 may be disposed on the central axis A2 extending in the front-rear direction of the chamber space 501.

In an embodiment, the first leg 411 and the second leg 412 may be disposed to contact adjacent walls 511, 512, 513, and 514 surrounding a pair of corners facing each other among the corners where the first to fourth walls are continuous with each other.

In this case, the distance between the first fixed contactor 311 and any one of the first leg 411 and the second leg 412 may be defined as the first distance d1. In addition, the distance between the second fixed contactor 312 and the other one of the first leg 411 and the second leg 412 may be defined as the second distance d2.

In the illustrated embodiment, the first distance d1 and the second distance d2 may be longer than when the first fixed contactor 311 and the second fixed contactor 312 are disposed at other positions inside the chamber space 501. That is, as the first leg 411 and the second leg 412, which each accommodate the plurality of sub PCBs 450, sub connectors 460, and sub switches 470, are spaced apart from each other maximally, the first distance d1 and the second distance d2 may also be maximized.

Accordingly, a sufficient insulating distance between the main contact part 300 and the sub contact part 400 may be secured.

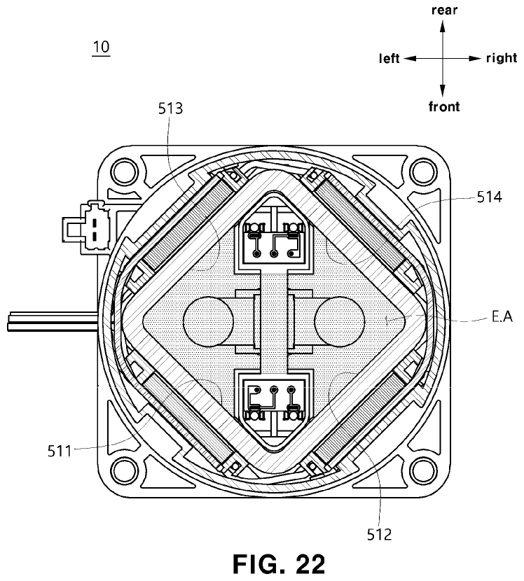

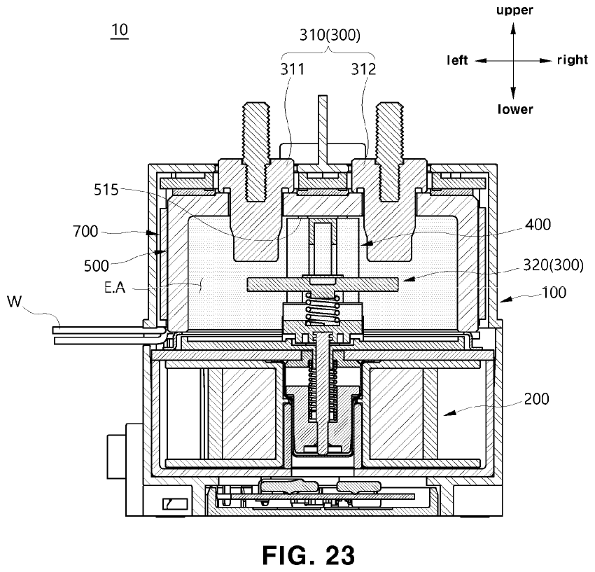

Referring to FIGS. 22 and 23, an arc extinguishing area E.A formed inside the arc chamber 500 of the DC relay 10 according to an embodiment of the present disclosure is illustrated. The arc extinguishing area E.A may be defined as a space in which an arc is extinguished and may be extended among the chamber space 501.

By the above-described configuration, the insulating distance between the main contact part 300 and the sub contact part 400 becomes the largest, and at the same time, the arc extinguishing area E.A may be expanded compared to the existing area.

In addition, the magnet part 740 for forming a magnetic field in the chamber space 501 is provided in the arc inducing part 700 disposed outside the arc chamber 500. The magnet part 740 is configured to form a magnetic field in the chamber space 501 outside the arc chamber 500. Therefore, the arc extinguishing area E.A may be expanded by the space occupied by the magnet part 740 among the chamber space 501.

Accordingly, the arc may be sufficiently extinguished and extended by expanding the arc extinguishing area E.A, and may be discharged to the outside the chamber space 501.

The above effect can be achieved without shape deformation of the upper frame 110. That is, as the arc chamber 500 is formed to have a rectangular cross-section, a predetermined space is formed between the upper frame 110 and the arc chamber 500. The arc inducing part 700 is disposed in the above space, that is, a space surrounded by the upper frame 110 and the arc chamber 500.

Therefore, a sufficient insulating distance between the main contact part 300 and the sub contact part 400 is secured, and the design change of other components of the DC relay 10 can be minimized as the arc extinguishing area E.A is increased.

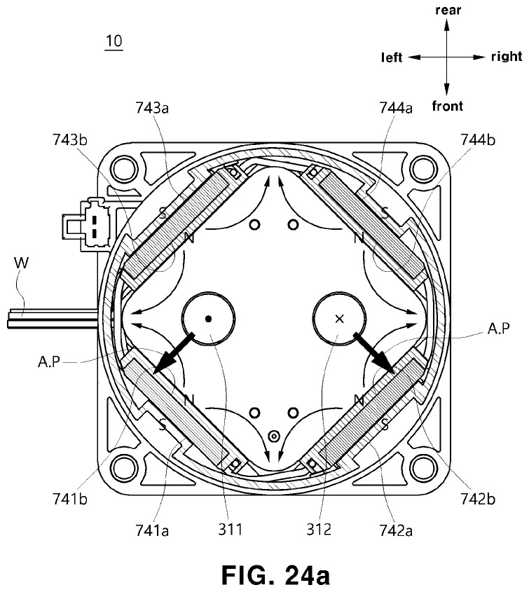

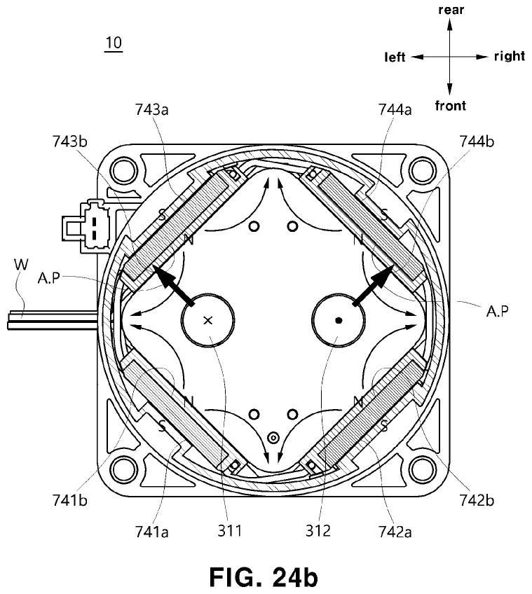

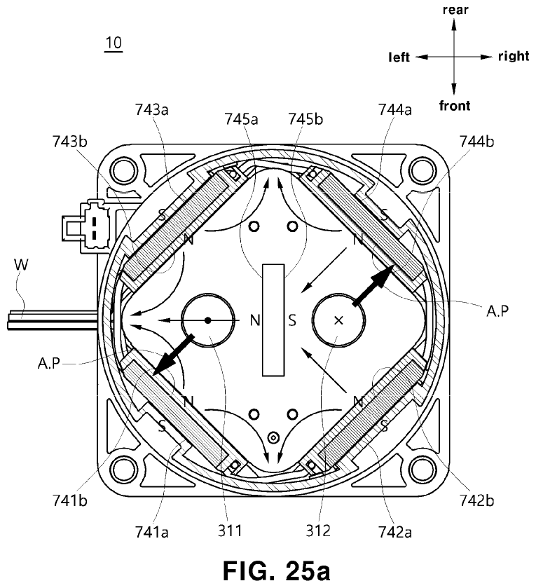

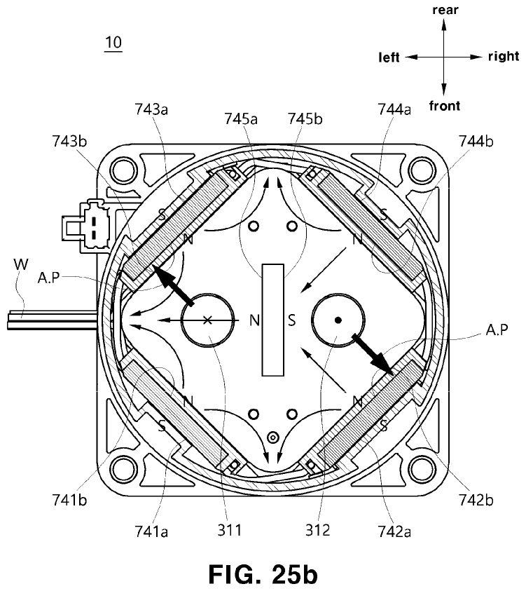

Referring to FIGS. 24 to 25, a magnetic field formed in the chamber space 501 of the DC relay 10 according to an embodiment of the present disclosure and an arc path A.P formed by a magnetic force formed according to the magnetic field are illustrated.

In the illustrated embodiment, the symbol “⊙” displayed on the fixed contactor 310 means that current passes through the fixed contactor 310 to the movable contactor 320. In other words, the current passes through the fixed contactor 310 marked with “⊙” in a direction that penetrates the ground.

In the illustrated embodiment, the symbol “x” displayed on the fixed contactor 310 means that current pass through the movable contactor 320 to the fixed contactor 310. In other words, the current passes through the fixed contactor 310 marked “x” in a direction that penetrates the ground.

In addition, in the illustrated embodiment, the arrows of the solid lines radiating from each magnet 741, 742, 743, 744, and 745 or converging to each magnet 741, 742, 743, 744, and 745 mean the direction of the magnetic field formed by each magnet 741, 742, 743, 744, and 745.

Referring to FIG. 24(a), a magnetic field formed inside the arc chamber 500 by the arc inducing part 700 and an arc path A.P according to the magnetic field is illustrated. In the illustrated embodiment, the current sequentially passes through the second fixed contactor 312 and the movable contactor 320, which are located on the right side, and is then passed to the outside through the first fixed contactor 311, which is located on the left side.

In this state, the first to fourth magnet outer surfaces 741a, 742a, 743a, and 744a are magnetized to S pole. In addition, the first to fourth magnet inner surfaces 741b, 742b, 743b, and 744b are magnetized to N pole. Therefore, the direction of the magnetic field formed by the first to fourth magnets 741, 742, 743, and 744 is a direction diverging from the inner surfaces of the first to fourth magnet inner surfaces 741b, 742b, 743b, and 744b and converging to the first to fourth magnet outer surfaces 741a, 742a, 743a, and 744a.

Accordingly, a magnetic field in a direction toward the left side is formed near the first fixed contactor 311 and a magnetic field in a direction toward the right side is formed near the second fixed contactor 312.

When the Fleming's left hand rule is applied to the first fixed contactor 311, the direction of the magnetic force formed by the current and magnetic field is formed toward the left side of the front. Accordingly, the arc path A.P may also be formed toward the left side of the front, and may proceed in a direction away from the fixed contactor 310 and the sub contact part 400.

When the Fleming's left hand rule is applied to the second fixed contactor 312, the direction of magnetic force formed by the current and magnetic field is formed toward the right side of the front. Accordingly, the arc path A.P may also be formed toward the right side of the front, and may proceed in a direction away from the fixed contactor 310 and the sub contact part 400.

Referring to FIG. 24(b), an embodiment in which the direction of current conduction is changed is illustrated. In the illustrated embodiment, the current sequentially passes through the first fixed contactor 311 and the movable contactor 320, which are located on the left side, and is then passed to the outside through the second fixed contactor 312, which is located on the right side.

In this case, the polarity of each magnet 741, 742, 743, and 744 and the direction of the magnetic field formed accordingly are the same as the illustrated embodiment in FIG. 24(a).

When the Fleming's left hand rule is applied to the first fixed contactor 311, the direction of the magnetic force formed by the current and magnetic field is formed toward the left side of the rear. Accordingly, the arc path A.P may also be formed toward the left side of the front, and may proceed in a direction away from the fixed contactor 310 and the sub contact part 400.

When the Fleming's left hand rule is applied to the second fixed contactor 312, the direction of magnetic force formed by the current and magnetic field is formed toward the right side of the rear. Accordingly, the arc path A.P may also be formed toward the right side of the rear, and may proceed in a direction away from the fixed contactor 310 and the sub contact part 400.

Referring to FIG. 25(a), in an embodiment in which the fifth magnet 745 is added, a magnetic field formed inside the arc chamber 500 by the arc inducing part 700 and an arc path A.P according to the magnetic field is illustrated. In the illustrated embodiment, the current sequentially passes through the second fixed contactor 312 and the movable contactor 320, which are located on the right side, and is then passed to the outside through the first fixed contactor 311, which is located on the left side.

In this state, the first to fourth magnet outer surfaces 741a, 742a, 743a, and 744a are magnetized to S pole. In addition, the first to fourth magnet inner surfaces 741b, 742b, 743b, and 744b are magnetized to N pole. Furthermore, the fifth magnet outer surface 745a is magnetized to N pole, and the fifth magnet inner surface 745b is magnetized to S pole.

Therefore, the direction of the magnetic field formed by the first to fourth magnets 741, 742, 743, and 744 is a direction diverging from the first to fourth magnet inner surfaces 741b, 742b, 743b, and 744b and converging to the first to fourth magnet outer surfaces 741a, 742a, 743a, and 744a. In addition, the direction of the magnetic field formed by the fifth magnet 745 is a direction diverged from the fifth magnet outer surface 745a converging to the fifth magnet inner surface 745b.

Furthermore, as the fifth magnet 745 is provided, a magnetic field is also formed between the first to fifth magnets 741, 742, 743, 744, and 745.

Specifically, a magnetic field in a direction from the fifth magnet outer surface 745a toward the first and third magnet outer surfaces 741a and 743a is formed. In addition, a magnetic field in the direction of the second and fourth magnet inner surfaces 742b, 744b toward the fifth magnet inner surface 745b is formed.

Accordingly, a magnetic field in a direction toward the left is formed in both the vicinity of the first fixed contactor 311 and the second fixed contactor 312.

When the Fleming's left hand rule is applied to the first fixed contactor 311, the direction of the magnetic force formed by the current and magnetic field is formed toward the left side of the front. Accordingly, the arc path A.P may also be formed toward the left side of the front, and may proceed in a direction away from the fixed contactor 310 and the sub contact part 400.

When the Fleming's left hand rule is applied to the second fixed contactor 312, the direction of magnetic force formed by the current and magnetic field is formed toward the right side of the rear. Accordingly, the arc path A.P may also be formed toward the right side of the rear, and may proceed in a direction away from the fixed contactor 310 and the sub contact part 400.

Referring to FIG. 25(b), an embodiment in which the direction of current conduction is changed is illustrated. In the illustrated embodiment, the current sequentially passes through the first fixed contactor 311 and the movable contactor 320, which are located on the left side, and is then passed to the outside through the second fixed contactor 312, which is located on the right side.

In this case, the polarity of each magnet 741, 742, 743, 744, and 745 and the direction of the magnetic field formed accordingly are the same as the illustrated embodiment in FIG. 25(a).

When the Fleming's left hand rule is applied to the first fixed contactor 311, the direction of the magnetic force formed by the current and magnetic field is formed toward the left side of the rear. Accordingly, the arc path A.P may also be formed toward the left side of the rear, and may proceed in a direction away from the fixed contactor 310 and the sub contact part 400.

When the Fleming's left hand rule is applied to the second fixed contactor 312, the direction of magnetic force formed by the current and magnetic field is formed toward the right side of the rear. Accordingly, the arc path A.P may also be formed toward the right side of the rear, and may proceed in a direction away from the fixed contactor 310 and the sub contact part 400.

Therefore, the DC relay 10 according to the embodiment of the present disclosure can induce the generated arc in a direction that moves away from the fixed contactor 310 and the sub contact part 400. Accordingly, damage to the fixed contactor 310 and the sub contact part 400 by the generated arc may be minimized.

In addition, even if the direction of current passing through the fixed contactor 310 and the movable contactor 320 is changed, the arc is induced in a direction that moves away from the fixed contactor 310 and the sub contact part 400. Therefore, the operator or user can connect an external power source and external load without considering the polarity of the fixed contactor 310 and the main terminal 610 coupled thereto and electrically connected thereto, thereby improving workability and convenience.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: DC relay | 100: frame |
| 110: upper frame | 111: upper space |
| 112: coupling protrusion | 113: support protrusion |
| 114: upper opening | 115: upper separation wall |
| 120: lower frame | 121: lower space |
| 122: coupling groove | 123: PCB accommodation part |
| 130: PCB frame | 131: PCB |
| 140: support plate | 141: support groove |
| 142: support through hole | 150: first insulating plate |
| 151: holder support part | 152: holder through hole |
| 200: core part | 210: stationary core |
| 220: movable core | 230: yoke |
| 240: bobbin | 250: coil |
| 251: trip coil | 252: holding coil |
| 260: core spring | 270: yoke ring |
| 280: cylinder | 300: main contact part |
| 310: fixing contactor | 311: first fixed contactor |
| 312: second fixed contactor | 320: movable contactor |
| 330: housing | 340: cover |
| 350: contact spring | 360: shaft |
| 400: sub contact part | 401: contact holder |
| 410: body part | 411: first leg |
| 412: second leg | 413: bridge |
| 420: switch accommodation part | 421: first switch accommodation |
| | part |
| 422: second switch accommodation | 430: terminal accommodation part |
| part | |
| 431: first terminal accommodation | 432: second terminal |
| part | accommodation part |
| 440: terminal partition member | 441: first terminal partition |
| | member |
| 442: second terminal partition | 450: sub PCB |
| member | |
| 451: first sub PCB | 451: second sub PCB |
| 460: sub connector | 461: first sub connector |
| 462: second sub connector | 470: sub switch |
| 471: first sub switch | 472: second sub switch |
| 500: arc chamber | 501: chamber space |
| 510: wall body part | 511: first wall |
| 512: second wall | 513: third wall |
| 514: fourth wall | 515: fifth wall |
| 520: opening part | 521: main opening part |
| 521a: first main opening part | 521b: second main opening part |
| 522: sub opening part | 522a: first sub opening part |
| 522b: second sub opening part | 523: pipe opening part |
| 530: sealing member | 600: terminal part |
| 610: main terminal | 611: first main terminal |
| 612: second main terminal | 620: sub terminal |
| 621: first sub terminal | 622: second sub terminal |
| 630: pipe member | 700: arc inducing part |
| 710: magnet housing | 711: first support wall |
| 711a: first magnet space part | 712: second support wall |
| 712a: second magnet space part | 713: third support wall |
| 713a: third magnet space part | 714: fourth support wall |
| 714a: fourth magnet space part | 715: cover member |
| 720: arc opening part | 721: first arc opening part |
| 722: second arc opening part | 723: conductive wire |
| | accommodation part |
| 724: conductive wire groove | 730: second insulating plate |
| 740: magnet part | 741: first magnet part |
| 741a: first magnet outer surface | 741b: first magnet inner surface |
| 742: second magnet unit | 742a: second magnet outer surface |
| 742b: second magnet inner surface | 743: third magnet part |
| 743a: third magnet outer surface | 743b: third magnet inner surface |
| 744: fourth magnet part | 744a: fourth magnet outer surface |
| 744b: fourth magnet inner surface | 745: fifth magnet part |
| 745a: fifth magnet outer surface | 745b: fifth magnet inner surface |
| 750: magnet cover member | 750a: first magnet cover member |
| 750b: second magnet cover member | 751: first extension part |
| 752: second extension part | 753: third extension part |
| S: accommodation space | W: conductive wire member |
| d1: first position | d2: second distance |
| E.A: arc extinguishing area | A.P: arc path |

1. An arc inducing part, comprising:
a magnet housing coupled to the outside of an arc chamber, wherein the arc chamber partially accommodates a fixed contactor; and
a magnet part accommodated in a magnet space formed in the magnet housing to form a magnetic field inside the arc chamber,
wherein a plurality of fixed contacts are provided and the plurality of fixed contacts are disposed to be spaced apart from each other in one direction inside the arc chamber, and
wherein the magnet part is disposed along the other direction that forms a predetermined angle with the one direction.

2. The arc inducing part of claim 1, wherein the magnet housing comprises:
a support wall that partially surrounds an outer circumferential surface of the arc chamber; and
a cover member that surrounds one surface of the arc chamber in a height direction and is continuous with the support wall, respectively, and
wherein the magnet space is formed inside the support wall.

3. The arc inducing part of claim 2, wherein the magnet space is formed through the support wall in a thickness direction.

4. The arc inducing part of claim 2, wherein a plurality of support walls is provided, and the plurality of the support walls are disposed to surround different portions of the outer circumferential surface of the arc chamber, and
wherein the magnet part includes a plurality of magnets, and the plurality of magnets are each accommodated in a plurality of magnet spaces to form a magnetic field inside the arc chamber.

5. The arc inducing part of claim 4, wherein the plurality of support walls are disposed to be spaced apart from each other by a predetermined distance along the outer circumference of the cover member.

6. The arc induction part of claim 4, wherein the plurality of magnets comprises:
a magnet outer surface that is one surface opposite to the arc chamber; and
a magnet inner surface that is the other surface opposite to the outer surface of the magnet and facing the arc chamber, and
wherein each of the magnet outer surfaces of the plurality of magnets is magnetized with the same polarity.

7. The arc inducing part of claim 2, wherein the support wall comprises:
a first support wall and a third support wall that are disposed to face each other with the arc chamber interposed therebetween and extend in one direction; and
a second support wall and a fourth support wall that are disposed to face each other with the arc chamber interposed therebetween and extend in the other direction.

8. The arc inducing part of claim 7, wherein the support wall has a horizontal cross-section with the first support wall, the second support wall, the third support wall, and the fourth support wall as one side, respectively, and
the support wall has a diamond shape with one diagonal line in one direction, in which the plurality of fixed contactors are disposed side by side.

9. The arc inducing part of claim 7, wherein the first support wall and the third support wall extend parallel to each other by the same length, and
the second support wall and the fourth support wall extend parallel to each other by the same length.

10. The arc inducing part of claim 1, wherein the shortest distance between any one of a plurality of fixed contactors and the magnet part is different from the shortest distance between the other one of the plurality of fixed contactors and the magnet part.

11. The arc inducing part of claim 1, comprising:
a magnet cover member coupled to cover the magnet housing and the magnet part from the outside to support the magnet housing and the magnet part from the outside.

12. The arc inducing part of claim 11, wherein the magnet part comprises: a plurality of magnets disposed to be spaced apart from each other, and
wherein the magnet cover member comprises:
a first extension part for extending in one direction to cover any one of the plurality of magnets disposed adjacent to each other from the outside;
a second extension part continuous with the first extension part to cover a space between the plurality of magnets disposed adjacent to each other; and
a third extension part continuous with the second extension part to cover the other of the plurality of magnets disposed adjacent to each other from the outside.

13. The arc inducing part of claim 12, wherein the first extension part and the third extension part extend in a planar shape, and
the second extension part extends in a curved shape including at least one curved portion.

14. A direct current (DC) relay, comprising:
a plurality of fixed contactors electrically connected to an external power source or an external load, and disposed to be spaced apart in one direction;
a movable contactor provided to be lifted up and down in a direction toward and opposite to the fixed contact, and configured to be in contact with or spaced apart from the fixed contactor;
an arc chamber having a chamber space formed therein to accommodate portions of a plurality of fixed contactors and the movable contactor; and
an arc inducing part that surrounds the outside of the arc chamber and is coupled to the arc chamber to form a magnetic field in the chamber space,
wherein the arc chamber comprises:
a plurality of walls for surrounding the chamber space and extending in one direction and another direction, respectively, and
wherein the arc inducing part comprises:
a plurality of magnets disposed adjacent to each of the plurality of walls and extending in the same direction as the plurality of walls.

15. The direct current relay of claim 14, wherein the arc inducing part comprises:
a magnet housing that accommodates a plurality of the magnets to be spaced apart from each other and is coupled to the arc chamber; and
a magnet cover member that covers a pair of magnets disposed adjacent to each other among the plurality of the magnets and is coupled to the magnet housing.

16. The direct current relay of claim 15, wherein the magnet cover member comprises a plurality of extension parts that extend in a plate shape, are continuous with each other, cover each of the pair of magnets disposed adjacent to each other, and are coupled to the magnet housing.
